(19) United States
(12) Patent Application Publication
(10) Pub. No.: US 2011/0096915 A1
(43) Pub. Date: Apr. 28, 2011

(54) AUDIO SPATIALIZATION FOR CONFERENCE CALLS WITH MULTIPLE AND MOVING TALKERS

(75) Inventor: Elias Nemer, Irvine, CA (US)

(73) Assignee: BROADCOM CORPORATION, Irvine, CA (US)

(21) Appl. No.: 12/910,188

(22) Filed: Oct. 22, 2010

Related U.S. Application Data
(60) Provisional application No. 61/254,420, filed on Oct. 23, 2009.

(51) Int. Cl. H04M 1/00

(52) U.S. Cl. 379/158

(57) ABSTRACT

Systems and methods are described that utilize audio spatialization to help at least one listener on one end of a communication session differentiate between multiple talkers on another end of the communication session. In accordance with one embodiment, an audio teleconferencing system obtains speech signals originating from different talkers on one end of the communication session, identifies a particular talker in association with each speech signal, and generates mapping information sufficient to assign each speech signal associated with each identified talker to a corresponding audio spatial region. A telephony system communicatively connected to the audio teleconferencing system receives the speech signals and the mapping information, assigns each speech signal to a corresponding audio spatial region based on the mapping information, and plays back each speech signal in its assigned audio spatial region.

### CROSS REFERENCE TO RELATED APPLICATIONS

This application claims the benefit of U.S. Provisional Patent Application No. 61/254,420, filed on Oct. 23, 2009, the entirety of which is incorporated by reference herein.

### BACKGROUND OF THE INVENTION

1. Field of the Invention

The present invention generally relates to communications systems and devices that support conference calls, speakerphone calls, or other types of communication sessions that allow for multiple and moving talkers on at least one end of the session.

2. Background

Certain conventional teleconferencing systems and telephones operating in conference mode can enable multiple and moving persons in a conference room or similar setting to speak with one or more persons at a remote location. For convenience, the conference room will be referred to in this section as the “near end” of the communication session and the remote location will be referred to as the “far end.” Many such conventional systems and telephones are designed to capture audio in a manner that does not vary in relation to the location of a currently-active audio source; thus, for example, the systems/phones will capture audio in the same way regardless of the location of the current near-end talker(s). Other such conventional systems and phones are designed to use beamforming techniques to enhance the quality of the audio received from the presumed or estimated location of an active audio source by filtering out audio received from other locations. The active audio source is typically a current near-end talker, but could also be any other noise source.

Regardless of how such conventional systems and phones capture audio, the audio that is ultimately transmitted to the remote listeners will typically be played back by a telephony system or device on the far end in a manner that does not vary in relation to the identity and/or location of the current near-end talker(s). This is true regardless of the playback capabilities of the far-end system or device; for example, this is true regardless of whether the far-end system or device provides mono, stereo or surround sound audio playback. Consequently, the remote listeners may have a difficult time differentiating between the voices of the various near-end talkers, all of which are played back in the same way. Differentiating between the voices can of the various near-end talkers can become particularly difficult in situations where one or more near-end talkers are moving around and/or when two or more near-end talkers are talking at the same time.

Similar difficulties to those described above could conceivably be encountered in other systems, such as online gaming systems, that are capable of capturing the voices of multiple and moving near-end talkers for transmission to one or more remote listeners, or systems that are capable of recording the voices of multiple and moving talkers to a storage medium for subsequent playback to one or more listeners.

### BRIEF SUMMARY OF THE INVENTION

Systems and methods are described herein that utilize audio spatialization to help at least one listener on one end of a communication session differentiate between multiple talkers on another end of the communication session. In accordance with one embodiment, an audio teleconferencing system obtains speech signals originating from different talkers on one end of the communication session, identifies a particular talker in association with each speech signal, and generates mapping information sufficient to assign each speech signal associated with each identified talker to a corresponding audio spatial region. A telephony system communicatively connected to the audio teleconferencing system receives the speech signals and the mapping information, assigns each speech signal to a corresponding audio spatial region based on the mapping information, and plays back each speech signal in its assigned audio spatial region.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example communications system in accordance with an embodiment of the present invention that utilizes audio spatialization to help at least one listener on one end of a communication session differentiate between multiple talkers on another end of the communication session.

FIG. 2 is a block diagram of an example audio teleconferencing system in accordance with an embodiment of the present invention that performs speaker identification and audio spatialization support functions.

FIG. 3 is a block diagram that illustrates one approach to performing direction of arrival (DOA) estimation in accordance with an embodiment of the present invention.

FIG. 4 is a block diagram of an example audio teleconferencing system in accordance with an embodiment of the present invention that performs DOA estimation on a frequency sub-band basis using fourth-order statistics.

FIG. 5 is a block diagram of an example audio teleconferencing system in accordance with an embodiment of the present invention that steers a Minimum Variance Distortionless Response beamformer based on an estimated DOA.

FIG. 6 is a block diagram of an example audio teleconferencing system in accordance with an embodiment of the present invention that utilizes sub-band-based DOA estimation and multiple beamformers to detect simultaneous talkers and to generate spatially-filtered speech signals associated therewith.

FIG. 7 is a block diagram of an example speaker identification system that may be incorporated into an audio teleconferencing system in accordance with an embodiment of the present invention.

FIG. 8 is a block diagram of an example telephony system that utilizes audio spatialization to enable one or more listeners on one end of a communication session to distinguish between multiple talkers on another end of the communication session.

FIG. 9 depicts a flowchart of a method for using audio spatialization to help at least one listener on one end of a communication session differentiate between multiple talkers on another end of the communication session in accordance with an embodiment of the present invention.

FIG. 10 depicts a flowchart of an alternative method for using audio spatialization to help at least one listener on one end of a communication session differentiate between multiple talkers on another end of the communication session in accordance with an embodiment of the present invention.

FIG. 11 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example Communications Systems in Accordance with an Embodiment of the Present Invention

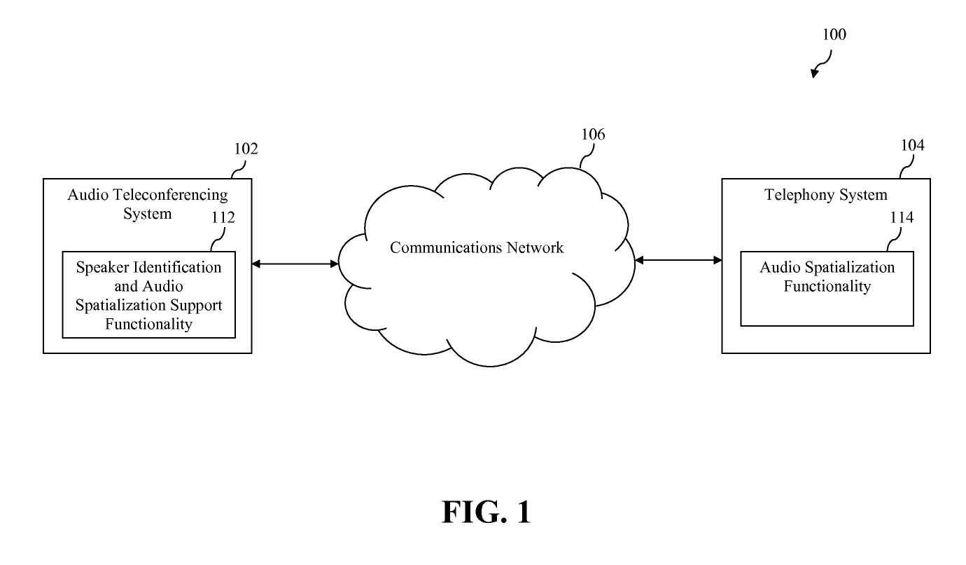

FIG. 1 is a block diagram of an example communications system 100 that utilizes audio spatialization to help at least one listener on one end of a communication session differentiate between multiple talkers on another end of the communication session in accordance with an embodiment of the present invention. As shown in FIG. 1, system 100 includes an audio teleconferencing system 102 that is communicatively connected to a telephony system 104 via a communications network 106. Communications network 106 is intended to broadly represent any network or combination of networks that can support voice communication between remote terminals such as between audio teleconferencing system 102 and telephony system 104. Communications network 106 may comprise, for example and without limitation, a circuit-switched network such as the Public Switched Telephone Network (PSTN), a packet-switched network such as the Internet, or a combination of circuit-switched and packet-switched networks.

Audio teleconferencing system 102 is intended to represent a system that enables multiple and moving talkers on one end of a communication session to communicate with one or more remote listeners on another end of the communication session. Audio teleconferencing system 102 may represent a system that is designed exclusively for performing group teleconferencing or may represent a system that can be placed into a conference or speakerphone mode of operation. Depending upon the implementation, audio teleconferencing system 102 may comprise a single integrated device, such as a desktop phone or smart phone, or a collection of interconnected components.

As shown in FIG. 1, audio teleconferencing system 102 includes speaker identification and audio spatialization support functionality 112. This functionality enables audio teleconferencing system 102 to obtain speech signals originating from different active talkers on one end of a communication session, to identify a particular talker in association with each speech signal, and to generate mapping information that can be used to assign each speech signal associated with each identified talker to a particular audio spatial region. In certain embodiments, the audio spatial region assignments remain constant, even when the identified talkers are physically moving in the room or talking simultaneously. As will be described in more detail herein, to perform these operations effectively, speaker identification and audio spatialization support functionality 112 may include, for example, logic for performing direction of arrival (DOA) estimation, acoustic beamforming, speaker recognition, and blind source separation.

Telephony system 104 is intended to represent a system or device that enables one or more remote persons to listen to the multiple talkers currently using audio teleconferencing system 102. Telephony system 104 receives the speech signals and the mapping information from audio teleconferencing system 102. Audio spatialization functionality 114 within telephony system 104 assigns each speech signal associated with each identified talker received from audio teleconferencing system 102 to a corresponding audio spatial region based on the mapping information, and then makes use of multiple loudspeakers to play back each speech signal in its assigned audio spatial region. As noted above, each one of the multiple talkers currently using audio teleconferencing system 102 may be assigned to a fixed audio spatial region. Thus, the listeners using telephony system 104 will perceive the audio associated with each talker to be emanating from a different audio spatial region. This advantageously enables the listeners to distinguish between the multiple talkers, even when such talkers are moving around and/or talking simultaneously. Depending upon the implementation, telephony system 104 may comprise a single integrated device or a collection of separate but interconnected components. Regardless of the implementation, telephony system 104 must include two or more loudspeakers to support the audio spatialization function.

### C. Example Audio Teleconferencing System in Accordance with an Embodiment of the Present Invention

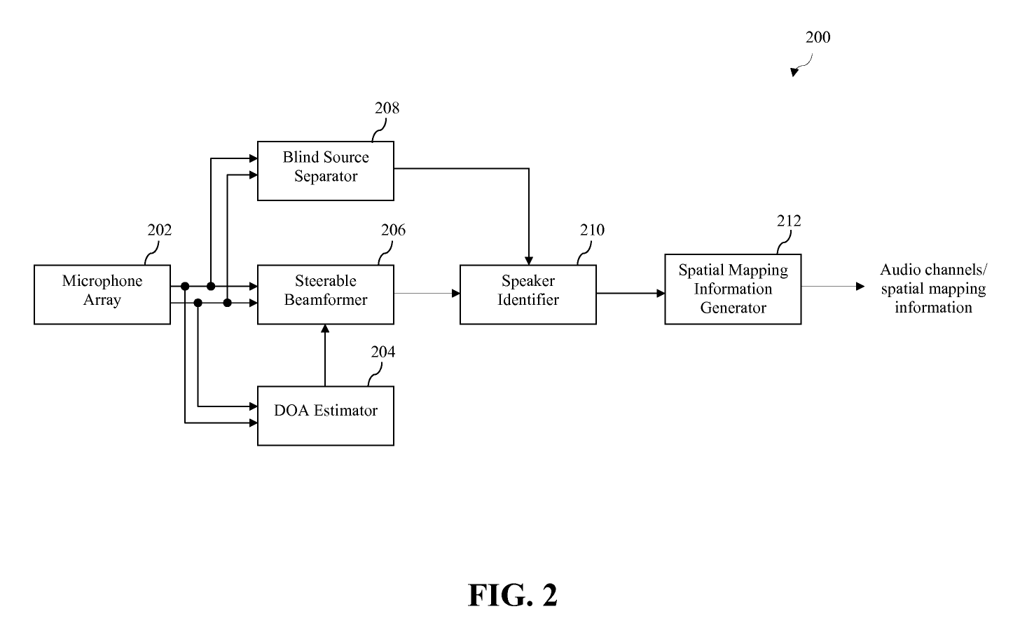

FIG. 2 is a block diagram of an example audio teleconferencing system 200 that performs speaker identification and audio spatialization support functions in accordance with an embodiment of the present invention. System 200 represents one example embodiment of audio teleconferencing system 102 as described above in reference to system 100 of FIG. 1. As shown in FIG. 2, system 200 includes a plurality of interconnected components including a microphone array 202, a direction of arrival (DOA) estimator 204, a steerable beamformer 206, a blind source separator 208, a speaker identifier 210 and a spatial mapping information generator 212. Each of these components will now be briefly described, and additional details concerning certain components will be provided in subsequent sub-sections. With the exception of microphone array 202, each of these components may be implemented in hardware, software, or as a combination of hardware and software.

Microphone array 202 comprises two or more microphones that are mounted or otherwise arranged in a manner such that at least a portion of each microphone is exposed to sound waves emanating from audio sources proximally located to system 200. Each microphone in microphone array 202 comprises an acoustic-to-electric transducer that operates in a well-known manner to convert such sound waves into a corresponding analog audio signal. The analog audio signal produced by each microphone in microphone array 202 is provided to a corresponding A/D converter (not shown in FIG. 1), which operates to convert the analog audio signal into a digital audio signal comprising a series of digital audio samples. The digital audio signals produced in this manner are provided to DOA estimator 204, steerable beamformer 206 and blind source separator 208. The digital audio signals output by microphone array 202 are represented by two arrows in FIG. 2 for the sake of simplicity. It is to be understood, however, that microphone array 202 may produce more than two digital audio signals depending upon how many microphones are included in the array.

DOA estimator 204 comprises a component that utilizes the digital audio signals produced by microphone array 202 to periodically estimate a DOA of speech sound waves emanating from an active talker with respect to microphone array 202. DOA estimator 204 periodically provides the current DOA estimate to steerable beamformer 206. In one embodiment, the estimated DOA is specified as an angle formed between a direction of propagation of the speech sound waves and an axis along which the microphones in microphone array 202 lie, which may be denoted θ. This angle is sometimes referred to as the angle of arrival. In another embodiment, the estimated DOA is specified as a time difference between the times at which the speech sound waves arrive at each microphone in microphone array 202 due to the angle of arrival. This time difference or lag may be denoted τ. Still other methods of specifying the estimated DOA may be used.

As will be described herein, in certain implementations, speech DOA estimator 204 can estimate a different DOA for each of two or more active talkers that are talking simultaneously. In accordance with such an implementation, speech DOA estimator 204 can periodically provide two or more estimated DOAs to steerable beamformer 206, wherein each estimated DOA provided corresponds to a different active talker.

Steerable beamformer 206 is configured to process the digital audio signals received from microphone array 202 to produce a spatially-filtered speech signal associated with an active talker. Steerable beamformer 206 is configured to process the digital audio signals in a manner that implements a desired spatial directivity pattern (or “beam pattern”) with respect to microphone array 202, wherein the desired spatial directivity pattern determines the level of response of microphone array 202 to sound waves received from different DOAs and at different frequencies. In particular, steerable beamformer 206 is configured to use an estimated DOA that is periodically provided by DOA estimator 204 to adaptively modify the spatial directivity pattern of microphone array 202 such that there is an increased response to speech signals received at or around the estimated DOA and/or such that there is decreased response to audio signals that are not received at or around the estimated DOA. This modification of the spatial directivity pattern of microphone array 202 in this manner may be referred to as “steering.”

As noted above, in certain embodiments, DOA estimator 204 is capable of periodically providing two or more estimated DOAs to steerable beamformer 206, wherein each of the estimated DOAs corresponds to a different simultaneously-active talker. In accordance with such an implementation, steerable beamformer 206 may actually comprise a plurality of steerable beamformers, each of which is configured to use a different one of the DOAs to modify the spatial directivity pattern of microphone array 202 such that there is an increased response to speech signals received at or around the particular estimated DOA and/or such that there is decreased response to audio signals that are not received at or around the particular estimated DOA. In further accordance with such an implementation, steerable beamformer 206 will produce two or more spatially-filtered speech signals, one corresponding to each estimated DOA concurrently provided by DOA estimator 204.

By periodically estimating the DOA of speech signals emanating from one or more active talkers and by steering one or more steerable beamformers based on the estimated DOA(s) in the manner described above, system 200 can adaptively “hone in” on active talkers and capture speech signals emanating therefrom in a manner that improves the perceptual quality and intelligibility of such speech signals even when the active talkers are moving around a conference room or other area in which system 200 is being utilized or when two or more active talkers are speaking simultaneously.

Blind source separator 208 is another component of system 200 that can used to process the digital audio signals received from microphone array 202 to detect simultaneous active talkers and to generate a speech signal associated with each active talker. In one implementation, when only one active talker is detected, DOA estimator 204 and steerable beamformer 206 are used to generate a corresponding speech signal, but when simultaneous active talkers are detected, blind source separator 208 is used to generate multiple corresponding speech signals. In another implementation, DOA estimator 204 and steerable beamformer 206 as well as blind source separator 208 operate in combination to generate multiple speech signals corresponding to multiple simultaneous talkers. In yet another embodiment, blind source separator 208 is not used at all (i.e., it is not a part of system 200), and DOA estimator 204 and steerable beamformer 206 perform all the steps necessary to generate multiple speech signals associated with simultaneous active talkers.

Speaker identifier 210 utilizes speaker recognition techniques to identify a particular talker in association with each speech signal generated by steerable beamformer 206 and/or blind source separator 208. As will be described in more detail herein, prior to or during the beginning of a communication session, speaker identifier 210 obtains speech data from each potential talker and generates a reference model therefrom. This process may be referred to as training. The reference model for each potential talker is then stored in a reference model database. Then, during the communication session, speaker identifier 210 applies a matching algorithm to try and match each speech signal generated by steerable beamformer 206 and/or blind source separator 208 with one of the reference models. If a match occurs, then the speech signal is identified as being associated with a particular legitimate talker.

Spatial mapping information generator 212 receives the speech signal(s) generated by steerable beamformer 206 and/or blind source separator 208 and an identification of a talker associated with each such speech signal from speaker identifier 210. Spatial mapping information generator 212 then produces mapping information that can be used by a remote terminal to assign each speech signal associated with each identified talker to a corresponding audio spatial region. Such spatial mapping information may include, for example, any type of information or data structure that associates a particular speech signal with a particular talker.

1. Example DOA Estimation Techniques

A plurality of different techniques may be applied by DOA estimator 204 to periodically obtain estimated DOAs corresponding to one or more active talkers. For example, DOA estimator 204 may apply a correlation-based DOA estimation technique, an adaptive eigenvalue DOA estimation technique, and/or any other DOA estimation technique known in the art.

Examples of various correlation-based DOA estimation techniques that may be applied by DOA estimator 204 are described in Chen et al., “Time Delay Estimation in Room Acoustic Environments: An Overview,” EURASIP Journal on Applied Signal Processing, Volume 2006, Article ID 26503, pages 1-9, 2006 and Carter, G. Clifford, “Coherence and Time Delay Estimation”, Proceedings of the IEEE, Vol. 75, No. 2, February 1987, the entirety of which are incorporated by reference herein.

Application of a correlation-based DOA estimation technique in an embodiment in which microphone array 202 comprises two microphones may involve computing the cross-correlation between audio signals produced by the two microphones for various lags and choosing the lag for which the cross-correlation function attains its maximum. The lag corresponds to a time delay from which an angle of arrival may be deduced.

So, for example, the audio signal produced by a first of the two microphones at time t, denoted x₁(t), may be represented as:

x₁(t)=h₁(t)*s₁(t)+n₁(t)

wherein s₁(t) represents a signal from an audio source at time t, n₁(t) is an additive noise signal at the first microphone at time t, h₁(t) represents a channel impulse response between the audio source and the first microphone at time t, and * denotes convolution. Similarly, the audio signal produced by the second of the two microphones at time t, denoted x₂(t), may be represented as:

x₂(t)=h₂(t)*s₁(t−τ)+n₂(t)

wherein τ is the relative delay between the first and second microphones due to the angle of arrival, n₂(t) is an additive noise signal at the second microphone at time t, and h₂(t) represents a channel impulse response between the audio source and the second microphone at time t.

The cross correlation between the two signals x₁(t) and x₂(t) may be computed for a range of lags denoted τₑₛₜ. The cross-correlation can be computed directly from the time signals as:

$${R}_{{x}_{1} {x}_{2}} ( {τ}_{est} ) = E [ {x}_{1} ( t ) \cdot {x}_{2} ( t + {τ}_{est} ) ] = \frac{1}{N} {\sum }_{n = 0}^{N - 1} {x}_{1} ( n ) \cdot {x}_{2} ( n + {τ}_{est} )$$

wherein E[•] stands for the mathematical expectation. The value of τₑₛₜ that maximizes the cross-correlation, denoted \hat{τ}_{DOA}, is chosen as the one corresponding to the best DOA estimate:

$${\hat{τ}}_{DOA} = arg {max}_{{τ}_{est}} {R}_{{x}_{1} {x}_{2}} ( {τ}_{est} ) .$$

The value \hat{τ}_{DOA} can then be used to deduce the angle of arrival θ in accordance with

$$cos ( θ ) = \frac{c \cdot {\hat{τ}}_{DOA}}{d}$$

wherein c represents the speed of sound and d represents the distance between the first and second microphones.

The cross-correlation may also be computed as the inverse Fourier Transform of the cross-PSD (power spectrum density):

Rₓ_{₁}ₓ_{₂}(τₑₛₜ)=∫W(w)·X₁(w)·X*₂(w)·e^{jwτ}^{ₑₛₜ}dw.

In addition, when power spectrum density formulas are used, various weighting functions over the frequency bands may be used. For instance, the so-called Phase Transform based weight has an expression:

$${R}_{01}^{p} ( {τ}_{est} ) = \int \frac{{X}_{1} ( f ) {X}_{2}^{*} ( f )}{\vert {X}_{1} ( f ) \vert \vert {X}_{2} ( f ) \vert} {e}^{j2π f {τ}_{est}} d f .$$

See, for example, Chen et al. as mentioned above, as well as Knapp and Carter, “The Generalized Correlation Method for Estimation of Time Delay,” IEEE Transactions on Acoustics, Speech, and Signal Processing, vol. 24, no. 4, pp. 320-327, 1976, and U.S. Pat. No. 5,465,302 to Lazzari et al. These references are incorporated by reference herein in their entirety.

As noted above, DOA estimator 204 may also apply various adaptive schemes to estimate the time delay between two microphones in an iterative way, by minimizing certain error criteria. See, for example, F. Reed et al., “Time Delay Estimation Using the LMS Adaptive Filter—Static Behavior,” IEEE Trans. On ASSP, 1981, p. 561, the entirety of which is incorporated by reference herein.

In the following, three additional techniques that may be applied by DOA estimator 204 to periodically obtain estimated DOAs corresponding to one or more active talkers will be described.

The first technique utilizes an adaptive filter to align two signals obtained from two microphones and then derives the estimated DOA from the coefficients of the optimum filter.

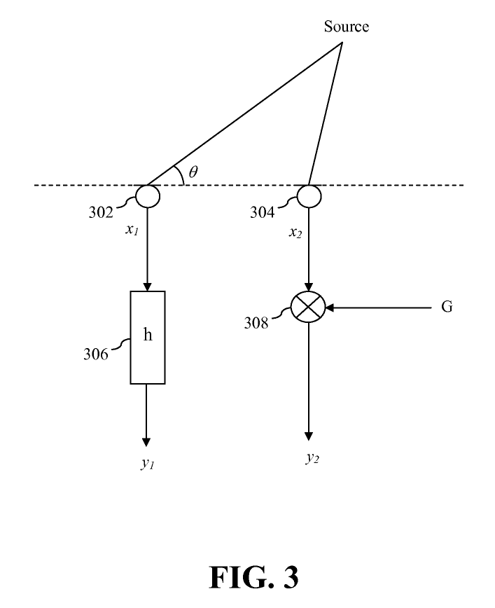

For example, as shown in FIG. 3, a filter h(n) (denoted with reference numeral 306) is applied to a first microphone signal x₁(n) generated by a first microphone 302 and a (scalar) gain is applied via a multiplier 308 to a second microphone signal x₂(n) generated by a second microphone 304, such that the correlation between the 2 resulting signals y₁(n) and y₂(n) is maximized. Then, from the coefficients of the filter, the delay between the two microphone signals is determined as:

$${τ}_{delay} = \frac{{\sum }_{n} ( {nT}_{S} ) \cdot {h}^{2} ( n )}{{\sum }_{n} {h}^{2} ( n )}$$

from which the DOA is derived as given earlier.

Maximizing the cross-correlation between y₁(n) and y₂(n) is equivalent to minimizing the difference between the cross-correlation and its maximum value, thus the criteria is to:

minimize ∇≡\sqrt{R_{y}_{₂}(0)R_{y}_{₁}(0)}−R_{y}_{₂}_{y}_{₁}; and

minimize ∇≡\sqrt{E[|y₂(n)|²]E[|y₁(n)|²]}−E[y*₂(n)y₁(n)].

If we further assume or impose a condition that both y₂ (n), yᵢ (n) have equal energies, the cost function simplifies to:

minimize ∇≡E[|y₁(n)|²]−E[y*₂(n)y₁(n)]; and

minimize ∇≡E[y₁(n)y*₁(n)]−E[y*₂(n)y₁(n)].

The derivative with respect to the filter coefficients is:

$$\frac{\partial ∇}{\partial {h}_{i}} = \frac{\partial ∇}{\partial {y}_{1}} \frac{\partial {y}_{1}}{\partial {h}_{i}} = E [ {y}_{1}^{*} ( n ) \frac{d {y}_{1} ( n )}{d {h}_{i}} ] - E [ G \cdot {x}_{2}^{*} ( n ) \frac{d {y}_{1} ( n )}{d {h}_{i}} ] .$$

Using the following:

$${y}_{1} ( n ) = {\sum }_{j} h ( j ) {x}_{1} ( n - j ) and \frac{d {y}_{1} ( n )}{d {h}_{i}} = {x}_{1} ( n - i )$$

and substituting:

$$\frac{\partial ∇}{\partial {h}_{i}} = {\sum }_{j} {h}^{*} ( j ) E [ {x}_{1}^{*} ( n - j ) {x}_{1} ( n - i ) ] - E [ G \cdot {x}_{2}^{*} ( n ) {x}_{1} ( n - i ) ] ,$$

setting

$$\frac{\partial ∇}{\partial {h}_{i}}$$

=0 yields:

$${\sum }_{j} {h}^{*} ( j ) {R}_{{x}_{1}^{*} {x}_{1}} ( j - i ) = G \cdot {R}_{{x}_{2}^{*} {x}_{1}} ( i )$$

or, in matrix form, (after taking conjugates of both sides):

$$[ \begin{matrix}{R}_{{x}_{1} {x}_{1}^{*}} ( 0 ) & … & {R}_{{x}_{1} {x}_{1}^{*}} ( K - 1 ) \\ ⋮ & ⋱ & ⋮ \\ {R}_{{x}_{1} {x}_{1}^{*}} ( 1 - K ) & … & {R}_{{x}_{1} {x}_{1}^{*}} ( 0 )\end{matrix} ] [ \begin{matrix}{h}_{0} \\ ⋮ \\ {h}_{k - 1}\end{matrix} ] = G \cdot [ \begin{matrix}{R}_{{x}_{2} {x}_{1}^{*}} ( 0 ) \\ ⋮ \\ {R}_{{x}_{2} {x}_{1}^{*}} ( K - 1 )\end{matrix} ] .$$

The filter coefficients can be thus found by solving the K matrix equations above. Moreover, an iterative update can be derived, of the form:

$${h}_{i} ( n + 1 ) = {h}_{i} ( n ) + μ \cdot \frac{\partial ∇}{\partial {h}_{i}}$$

with the gradient being approximated using instantaneous values:

$$\frac{\partial ∇}{\partial {h}_{i}} = {\sum }_{j} {h}^{*} ( j ) [ {x}_{1}^{*} ( n - j ) {x}_{1} ( n - i ) ] - [ G \cdot {x}_{2}^{*} ( n ) {x}_{1} ( n - i ) ]$$

$$or$$

$$\frac{\partial ∇}{\partial {h}_{i}} = {x}_{1} ( n - i ) \{ {\sum }_{j} {h}^{*} ( j ) {x}_{1}^{*} ( n - j ) - G \cdot {x}_{2}^{*} ( n ) \}$$

$$or$$

$$\frac{\partial ∇}{\partial {h}_{i}} = {x}_{1} ( n - i ) {e}^{*} ( n )$$

yielding the update equation:

hᵢ(n+1)=hᵢ(n)+μ·x₁(n−i)e*(n).

A second technique that may be applied by DOA estimator 204 involves performing DOA estimation in frequency sub-bands based on higher-order cross-cumulants. In accordance with such a technique, the second-order cross-correlation-based method described above is extended to the fourth-order cumulant, thereby providing a more robust approach to estimating the DOA of a speech signal across a plurality of frequency sub-bands. At least two advantages are provided by using such higher-order statistics: first, such higher-order statistics are more robust to the presence of Gaussian noise than the second-order counterparts, and, second, fourth order statistics can be used to detect the presence of speech, thus enabling the elimination of frequency sub-bands that do not contribute to valid DOA estimation.

The fourth-order cross-cumulant between two complex signals X₁ and X₂ at a given lag L can be defined as:

C_{X}_{₁}_{X}_{₂}⁴(L)=E[X₁²(n)X*₂²(n+L)]−E[X₁²(n)]E*[X₂²(n+L)]−2(E[X₁(n)X*₂(n+L)])².

See, for example, Nikias, C. L. and Petropulu A., Higher-Order Spectra Analysis: A Nonlinear Signal Processing Framework, Englewood Cliffs, N.J., Prentice Hall (1993), the entirety of which is incorporated by reference herein. To eliminate the effect of signal energy, a normalized cross-cumulant can be deduced by normalizing by the individual cumulants in accordance with:

$${Norm\_C}_{{X}_{1} {X}_{2}}^{4} ( L ) = \frac{{C}_{{X}_{1} {X}_{2}}^{4} ( L )}{\sqrt{{C}_{{X}_{1}}^{4} ( 0 ) {C}_{{X}_{2}}^{4} ( 0 )}}$$

It can be shown that the real part of the normalized cross-cumulant reaches maximum (negative) values for lag values corresponding to the delay between the two signals. (See Appendix in Section I, herein). Thus, by determining the value of L at which the real part of the normalized cross-cumulant reaches a maximum (negative) value, the DOA can be estimated as explained above.

In addition to using the fourth-order cross-cumulant between two channels to estimate the DOA, the cumulants at lag zero (or kurtosis) of the individual signals as well as the cross-kurtosis between the two signals can be used to identify frequency-sub-bands that that have speech energy and frequency sub-bands that have no speech energy. A weighting scheme can then by applied in which relatively less or no weight is applied to bands that have no speech energy when determining the estimated DOA. The individual kurtosis and cross-kurtosis of the 2 complex signals X₁ and X₂ are respectively:

C_{X}_{₁}⁴(0)=E[|X₁(n)|²|X₁(n)|²]−E[X₁²(n)]E[X*₁²(n)]−2(E[|X₁(n)|²])²

C_{X}_{₂}⁴(0)=E[|X₂(n)|²|X₂(n)|²]−E[X₂²(n)]E[X*₂²(n)]−2(E[|X₂(n)|²])²

C_{X}_{₁}_{X}_{₂}⁴(0)=E[X₁²(n)X*₂²(n)]−E[X₁²(n)]E*[X₂²(n)]−2(E[X₁(n)X*₂(n)])²

It can be shown that in any sub-band where there is no speech energy, all three entities will be near zero:

C_{X}_{₁}⁴(0)≈0 C_{X}_{₂}⁴(0)≈0 C_{X}_{₁}_{X}_{₂}⁴(0)≈0.

Furthermore, in sub-bands where there is harmonic speech energy, then all three entities will be much greater than zero, while the normalized cross-kurtosis is near unity (see Appendix in Section I):

$$\frac{\vert {C}_{{X}_{1} {X}_{2}}^{4} ( 0 ) \vert}{\sqrt{\vert {C}_{X 1}^{4} ( 0 ) \vert \vert {C}_{X 2}^{4} ( 0 ) \vert}} \approx 1.$$

Thus a weight can be deduced and applied to individual sub-bands during DOA estimation.

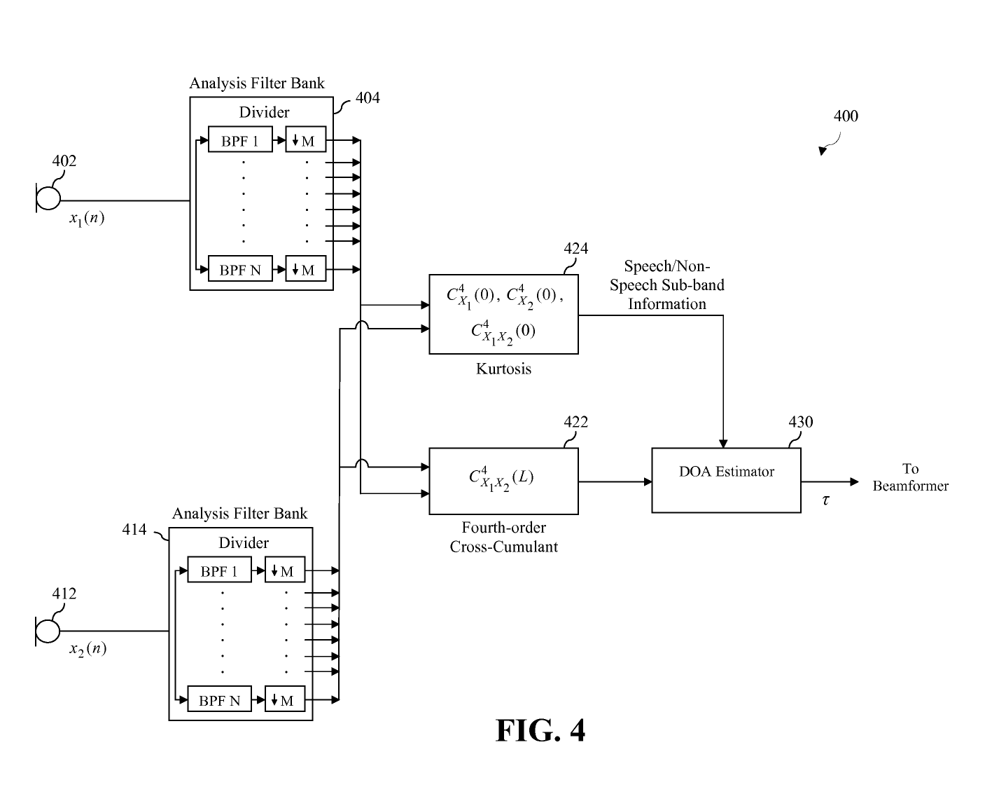

To help illustrate the foregoing concepts, FIG. 4 illustrates a block diagram of an example audio teleconferencing system 400 that performs DOA estimation on a sub-band basis using fourth-order statistics in accordance with one embodiment of the present invention. Audio teleconferencing system 400 may comprise one example implementation of audio teleconferencing system 200 of FIG. 2. As shown in FIG. 4, audio teleconferencing system 400 includes a number of interconnected components including a first microphone 402, a first analysis filter bank 404, a second microphone 412, a second analysis filter bank 414, a first logic block 422, a second logic block 424, and a DOA estimator 430.

First microphone 402 converts sound waves into a first microphone signal, denoted x₁(n), in a well-known manner. The first microphone signal x₁(n) is passed to first analysis filter bank 404. First analysis filter bank 404 includes a plurality of band-pass filters (BPFs) and associated down-samplers that operate to divide the first microphone signal x₁(n) into a plurality of first microphone sub-band signals, each of the plurality of first microphone sub-band signals being associated with a different frequency sub-band.

Second microphone 412 converts sound waves into a second microphone signal, denoted x₂(n), in a well-known manner. The second microphone signal x₂(n) is passed to a second analysis filter bank 414. Second analysis filter bank 414 includes a plurality of band-pass filters (BPFs) and associated down-samplers that operate to divide the second microphone signal x₂(n) into a plurality of second microphone sub-band signals, each of the plurality of second microphone sub-band signals being associated with a different frequency sub-band.

First logic block 422 receives the first microphone sub-band signals from first analysis filter bank 404 and the second microphone sub-band signals from second analysis filter bank 414 and processes these signals to determine, for each sub-band, a candidate lag value that maximizes a real part of a normalized fourth-order cross-cumulant that is calculated based on the first and second microphone sub-band signals in that sub-band. The normalized cross-cumulant may be determined in accordance with the equation set forth above for determining Norm_C_{X}_{₁}_{X}_{₂}⁴(L), which in turn may be determined based on the equation set forth above for determining C_{X}_{₁}_{X}_{₂}⁴(L). The candidate lags determined for the frequency sub-bands are passed to DOA estimator 430.

Second logic block 424 receives the first microphone sub-band signals from first analysis filter bank 404 and the second microphone sub-band signals from second analysis filter bank 414 and processes these signals to determine, for each sub-band, the kurtosis for each microphone signal as well as the cross-kurtosis between the two microphone signals. For example, the kurtosis for first microphone signal x₁(n) may be determined in accordance with the equation set forth above for determining C_{X}_{_{R}}⁴ (0), the kurtosis for second microphone signal x₂(n) may be determined in accordance with the equation set forth above for determining C_{X}_{₁}_{X}_{₂}⁴ (0), and the cross-kurtosis between the two microphone signals may be determined in accordance with the equation set forth above for determining C_{X}_{₁}_{X}_{₂}⁴(0). Based on these values and in accordance with principles discussed above, second logic block 424 renders a determination as to whether each sub-band comprises speech or non-speech information. Information concerning whether each sub-band comprises speech or non-speech information is then passed from second logic block 424 to DOA estimator 430.

DOA estimator 430 receives a candidate lag for each frequency sub-band from first logic block 422 and information concerning whether each frequency sub-band includes speech or non-speech information from second logic block 424 and then uses this data to select an estimated DOA, denoted τ in FIG. 4. DOA estimator 430 may determine the estimated DOA by using histogramming to identify a dominant lag among the sub-bands and/or by averaging or otherwise combining lags obtained for different sub-bands. The speech/non-speech information for each sub-band may be used by DOA estimator 430 to selectively ignore certain sub-bands that have been deemed not to include speech information. Such information may also be used by DOA estimator 430 to assign a relatively lower weight (or no weight at all) to a sub-band that is deemed not to include speech information in a process that determines the estimated DOA by combining lags obtained from different sub-bands. Still other approaches may be used for determining the estimated DOA from the candidate lags received from first logic block 422 and from the information concerning which sub-bands include speech or non-speech information received from second logic block 424.

The estimated DOA produced by DOA estimator 430 is passed to a steerable beamformer, such as steerable beamformer 206 of system 200. The estimated DOA can be used by the steerable beamformer to perform spatial filtering of audio signals received by a microphone array, such as microphone array 202 of system 200, in a manner described elsewhere herein.

Although audio teleconferencing system 400 includes only two microphones, persons skilled in the relevant art(s) will readily appreciate that the approach to DOA estimation represented by audio teleconferencing system 400 can readily be extended to systems that include more than two microphones. In such systems, like calculations to those described above can be performed with respect to each unique microphone pair in order to obtain candidate lags for each frequency sub-band and in order to identify frequency sub-bands that include or do not include speech information. Persons skilled in the relevant art(s) will further appreciate that other approaches than those described above may be used to perform DOA estimation in accordance with various alternate embodiments of the present invention.

Finally, a third technique that may be applied by DOA estimator involves estimating a DOA using an adaptive scheme similar to the first technique presented above, but using the 4^{th} order cumulant as a criteria to select the adaptive filter, instead of the 2^{nd} order based criteria of optimality.

It was shown in the foregoing description that the 4^{th} order cross cumulant reaches a maximum (negative value) when the two microphone signals are aligned in time. Therefore the criteria of optimality for filter 306 of FIG. 3 is to maximize the value of the cross cumulant, or equivalently, to minimize the difference between the cross-cumulant and its maximum possible value:

minimize ∇≡−\sqrt{C_{y}_{₁}⁴C_{y}_{₂}⁴}C_{y}_{₁}_{y}_{₂}⁴

by using the identities derived earlier for a harmonic signal:

C_{y}_{₁}⁴=−{E[|y₁(n)|²]}² C_{y}_{₂}⁴=−{E[|y₂(n)|²]}²

The criteria becomes

minimize ∇≡−E[|y₁(n)|²]E[|y₂(n)|²]+C_{y}_{₁}_{y}_{₂}⁴

The derivative of the first term is:

$$\begin{matrix}\frac{\partial E [ {\vert {y}_{1} ( n ) \vert}^{2} ] E [ {\vert {y}_{2} ( n ) \vert}^{2} ]}{\partial {h}_{i}} = 2 {G}^{2} E [ {\vert {x}_{2} ( n ) \vert}^{2} ] E [ {y}_{1}^{*} ( n ) \frac{d {y}_{1} ( n )}{d {h}_{i}} ] \\ = 2 {G}^{2} E [ {\vert {x}_{2} ( n ) \vert}^{2} ] \\ {\sum }_{j} {h}^{*} ( j ) E [ {x}_{1}^{*} ( n - j ) {x}_{1} ( n - i ) ]\end{matrix}$$

The expression of the second term is the 4^{th} order cross-cumulant between y₁, y₂ is:

C_{y}_{₁}_{y}_{₂}⁴=E[y₁²(n)y*₂²(n)]−E[y₁²(n)]−E*[y₂²(n)]−2(E[y₁(n)y*₂(n)])²

The derivative with respect to the filter coefficient is:

$$\frac{\partial {C}_{{y}_{1} {y}_{2}}^{4}}{\partial {h}_{i}} = E [ 2 {y}_{1} ( n ) \frac{\partial {y}_{1} ( n )}{\partial {h}_{i}} {y}_{2}^{* 2} ( n ) ] - E [ 2 {y}_{1} ( n ) \frac{\partial {y}_{1} ( n )}{\partial {h}_{i}} ] {E}^{*} [ {y}_{2}^{2} ( n ) ] - 4 ( E [ {y}_{1} ( n ) {y}_{2}^{*} ( n ) ] ) E [ {y}_{2}^{*} ( n ) \frac{\partial {y}_{1} ( n )}{\partial {h}_{i}} ] .$$

Using the identities

$${y}_{1} ( n ) = {\sum }_{j} h ( j ) {x}_{1} ( n - j ) and \frac{d {y}_{1} ( n )}{d {h}_{i}} = {x}_{1} ( n - i ) , \\ \frac{\partial {C}_{{y}_{1} {y}_{2}}^{4}}{\partial {h}_{i}} 2 {G}^{2} {\sum }_{j} h ( j ) \cdot E [ {x}_{1} ( n - j ) {x}_{1} ( n - i ) {x}_{2}^{* 2} ( n ) ] - 2 {G}^{2} {E}^{*} [ {x}_{2}^{2} ( n ) ] {\sum }_{j} h ( j ) E [ {x}_{1} ( n - j ) {x}_{1} ( n - i ) ] - 4 {G}^{2} {\sum }_{j} h ( j ) E [ {x}_{2}^{*} ( n ) {x}_{1} ( n - j ) ] E [ {x}_{2}^{*} ( n ) {x}_{1} ( n - i ) ]$$

Combining the derivatives of both terms yields

$$\frac{\partial ∇}{\partial {h}_{i}} = - 2 {G}^{2} E [ {\vert {x}_{2} ( n ) \vert}^{2} ] {\sum }_{j} {h}^{*} ( j ) E [ {x}_{1}^{*} ( n - j ) {x}_{1} ( n - i ) ] + 2 {G}^{2} {\sum }_{j} h ( j ) \cdot E [ {x}_{1} ( n - j ) {x}_{1} ( n - i ) {x}_{2}^{* 2} ( n ) ] - 2 {G}^{2} {E}^{*} [ {x}_{2}^{2} ( n ) ] {\sum }_{j} h ( j ) E [ {x}_{1} ( n - j ) {x}_{1} ( n - i ) ] - 4 {G}^{2} E [ {x}_{2}^{*} ( n ) {x}_{1} ( n - i ) ] {\sum }_{j} h ( j ) E [ {x}_{2}^{*} ( n ) {x}_{1} ( n - j ) ] .$$

Using the derived relation from 2^{nd} order and setting the derivative to zero yields:

$${\sum }_{j} h ( j ) \cdot E [ {x}_{1} ( n - j ) {x}_{1} ( n - i ) {x}_{2}^{* 2} ( n ) ] - {E}^{*} [ {x}_{2}^{2} ( n ) ] {\sum }_{j} h ( j ) E [ {x}_{1} ( n - j ) {x}_{1} ( n - i ) ] - 2 E [ {x}_{2}^{*} ( n ) {x}_{1} ( n - i ) ] {\sum }_{j} h ( j ) E [ {x}_{2}^{*} ( n ) {x}_{1} ( n - j ) ] = G \cdot E [ {\vert {x}_{2} ( n ) \vert}^{2} ] E [ {x}_{2}^{*} ( n ) {x}_{1} ( n - i ) ] .$$

Define the following:

Cₓ_{₁}ₓ_{₂}⁴(i,j)=E[x₁(n−j)x₁(n−i)x*₂²(n)]−E*[x₂²(n)]E[x₁(n−j)x₁(n−i)]−2E[x*₂(n)x₁(n−i)]E[x*₂(n)x₁(n−j)].

The optimality equations can be written as:

$${\sum }_{j} h ( j ) {C}_{{x}_{1} {x}_{2}}^{4} ( i , j ) = G \cdot E [ {\vert {x}_{2} ( n ) \vert}^{2} ] E [ {x}_{2}^{*} ( n ) {x}_{1} ( n - i ) ]$$

or in matrix form as:

$$[ \begin{matrix}{C}_{{x}_{1} {x}_{2}}^{4} ( 0 , 0 ) & ⋯ & {C}_{{x}_{1} {x}_{2}}^{4} ( 0 , K - 1 ) \\ ⋮ & ⋱ & ⋮ \\ {C}_{{x}_{1} {x}_{2}}^{4} ( 1 - K , 0 ) & ⋯ & {C}_{{x}_{1} {x}_{2}}^{4} ( 1 - K , 1 - K )\end{matrix} ] [ \begin{matrix}{h}_{0} \\ ⋮ \\ {h}_{k - 1}\end{matrix} ] = G \cdot [ \begin{matrix}E [ {\vert {x}_{2} ( n ) \vert}^{2} ] E [ {x}_{2}^{*} ( n ) {x}_{1} ( n ) ] \\ ⋮ \\ E [ {\vert {x}_{2} ( n ) \vert}^{2} ] E [ {x}_{2}^{*} ( n ) {x}_{1} ( n - K + 1 ) ]\end{matrix} ]$$

2. Example Beamforming Techniques

As noted above, steerable beamformer 206 is configured to use an estimated DOA provided by DOA estimator 204 to modify a spatial directivity pattern (or “beam pattern”) associated with microphone array 202 so as to provide an increased response to speech signals received at or around the estimated DOA and/or to provide a decreased response to audio signals that are not received at or around the estimated DOA. In certain implementations of the present invention, two or more steerable beamformers can be used in this manner to “hone in on” two or more simultaneous talkers. Any of a wide variety of beamformer algorithms can be used to this end, including both existing and subsequently-developed beamformer algorithms.

For the purpose of illustration, steerable beamformer 206 can be implemented in the frequency domain as described in Cox., H., et al., “Robust Adaptive Beamforming,” IEEE Trans. ASSP (Acoustics, Speech and Signal Processing) (35), No. 10, pp. 1365-1376, October 1987, the entirety of which is incorporated by reference herein. Such an exemplary implementation will now be described. However, as will be appreciated by persons skilled in the relevant art(s), other approaches may be used.

Given the Fourier transform of the microphone array input X(w), a beamformer output may be represented as:

Y(w)=A(w)X(w).

If the look direction θ (which in this case is the estimated direction of arrival provided by the DOA estimator) is known, the so-called Minimum Variance Distortionless Response (MVDR) beamformer that maximizes the array gain is given by:

$$A ( w ) = \frac{{Γ}^{- 1} ( w ) \cdot d ( w )}{{SV}^{*} ( w ) {Γ}^{- 1} ( w ) \cdot SV ( w )}$$

where SV(w) is the steering vector and Γ(w) is the cross-coherence matrix of the noise (if it is known) or that of the input X(w):

$$Γ ( w ) = ( \begin{matrix}1 & {Γ}_{{X}_{1} {X}_{2}} & ⋯ & {Γ}_{{X}_{1} {X}_{M}} \\ {Γ}_{{X}_{2} {X}_{1}} & 1 & ⋯ & {Γ}_{{X}_{2} {X}_{M - 1}} \\ ⋮ & ⋮ & ⋱ & ⋮ \\ {Γ}_{{X}_{M} {X}_{1}} & {Γ}_{{X}_{M} {X}_{2}} & ⋯ & 1\end{matrix} )$$

$${Γ}_{{X}_{1} {X}_{2}} ( w ) = \frac{{P}_{{X}_{1} {X}_{2}} ( w )}{\sqrt{{P}_{{X}_{1}} ( w ) \cdot {P}_{{X}_{2}} ( w )}}$$

The steering vector is written as a function of the array geometry, the direction of arrival, and the distance between sensors:

SV(w)=F(w,θ,d_{iC}_{_{S}})

wherein θ is the direction of arrival and d_{iC}_{_{S}} is the distance from sensor i to the center sensor C_{S}.

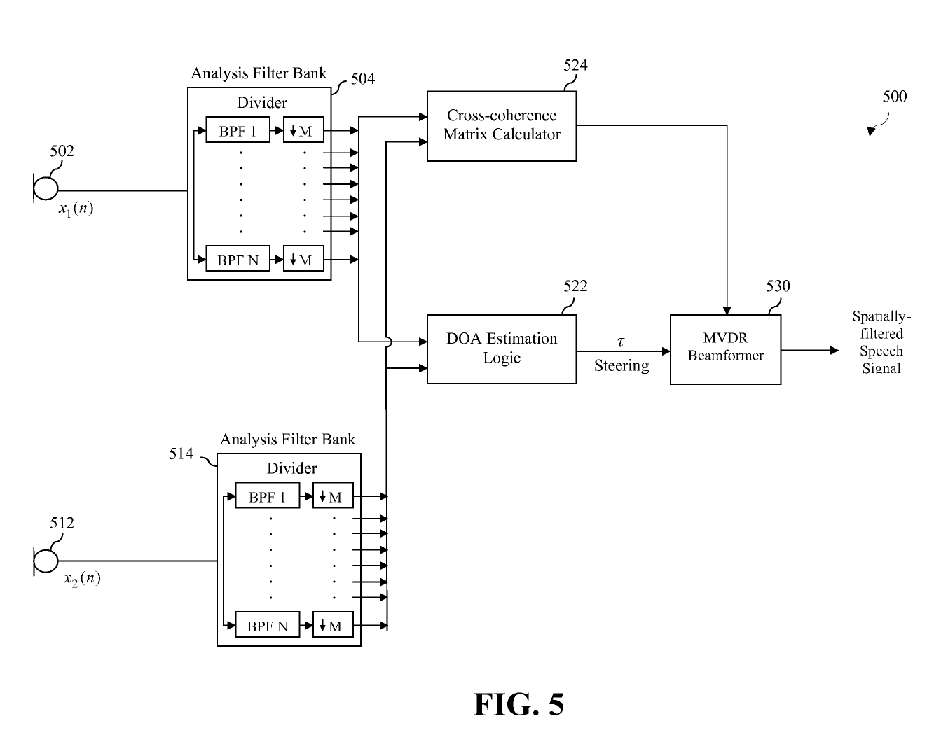

By way of further illustration, FIG. 5 is a block diagram of an example audio teleconferencing system 500 that uses an estimated DOA to steer an MVDR beamformer in accordance with one embodiment of the present invention. Audio teleconferencing system 500 may comprise one example implementation of audio teleconferencing system 200 of FIG. 2. As shown in FIG. 5, audio teleconferencing system 500 includes a number of interconnected components including a first microphone 502, a first analysis filter bank 504, a second microphone 512, a second analysis filter bank 514, DOA estimation logic 522, a cross-coherence matrix calculator 524, and an MVDR beamformer 526.

First microphone 502 converts sound waves into a first microphone signal, denoted x₁(n), in a well-known manner. The first microphone signal x₁(n) is passed to first analysis filter bank 504. First analysis filter bank 504 includes a plurality of band-pass filters (BPFs) and associated down-samplers that operate to divide the first microphone signal x₁(n) into a plurality of first microphone sub-band signals, each of the plurality of first microphone sub-band signals being associated with a different frequency sub-band.

Second microphone 512 generates a second microphone signal, denoted x₂(n), in a well-known manner. The second microphone signal x₂(n) is passed to a second analysis filter bank 514. Second analysis filter bank 514 includes a plurality of band-pass filters (BPFs) and associated down-samplers that operate to divide the second microphone signal x₂(n) into a plurality of second microphone sub-band signals, each of the plurality of second microphone sub-band signals being associated with a different frequency sub-band.

DOA estimation logic 522 receives the first microphone sub-band signals from first analysis filter bank 504 and the second microphone sub-band signals from second analysis filter bank 514 and processes these signals to determine an estimated DOA, denoted τ, which is then passed to MVDR beamformer 530. In one embodiment, DOA estimation logic 522 is implemented using first logic block 422, second logic block 424 and DOA estimator 430 of system 400, the operation of which is described above in reference to system 400 of FIG. 4, although DOA estimation logic 522 may be implemented in other manners as well.

Cross-coherence matrix calculator 524 also receives the first microphone sub-band signals from first analysis filter bank 504 and the second microphone sub-band signals from second analysis filter bank 514. Cross-coherence matrix calculator 524 processes these signals to compute a cross-coherence matrix, such as cross-coherence matrix Γ(w) as described above, for use by MVDR beamformer 530.

MVDR beamformer 530 receives the estimated DOA τ from DOA estimation logic 522 and the cross-coherence matrix from cross-coherence matrix calculator 524 and uses this data in a well-known manner to modify a beam pattern associated with microphones 502 and 512. In particular, MVDR beamformer 530 modifies the beam pattern such that signals from the estimated DOA are passed with no distortion relative to a reference response. The response power in certain directions outside of the estimated DOA is minimized

Although audio teleconferencing system 500 includes only two microphones, persons skilled in the relevant art(s) will readily appreciate that the beamforming approach represented by audio teleconferencing system 500 can readily be extended to systems that include more than two microphones. Persons skilled in the relevant art(s) will further appreciate that other approaches than those described above may be used to perform beamforming in accordance with various alternate embodiments of the present invention.

3. Detecting Multiple Simultaneous Talkers

As noted above, audio teleconferencing system 200 may be implemented such that it can detect multiple simultaneous talkers and obtain a different speech signal associated with each detected talker. Depending upon the implementation, this function can be performed by DOA estimator 204 operating in conjunction with steerable beamformer 206 and/or by blind source separator 208. Details regarding each approach will be provided below. Persons skilled in the relevant art(s) will appreciate that approaches other than those described below can also be used.

a. Detecting Multiple Simultaneous Talkers Via Sub-Band Based DOA Estimation and Beamforming

As described in a previous section, an audio teleconferencing system in accordance with an embodiment of the present invention performs DOA estimation by analyzing microphone signals generated by an array of microphones in a plurality of different frequency sub-bands to generate a candidate DOA (which may be defined as a lag, angle of arrival, or the like) for each sub-band. When only a single talker is active, such a DOA estimation process will generally return the same estimated DOA for each sub-band. However, when more than one talker is active, the DOA estimation process will generally yield different estimated DOAs in each sub-band. This is because different talkers will generally have different pitches—consequently, any given sub-band is likely to be dominated by one of the active talkers. An embodiment of the present invention leverages this fact to detect simultaneous active talkers and generate different spatially-filtered speech signals corresponding to each active talker.

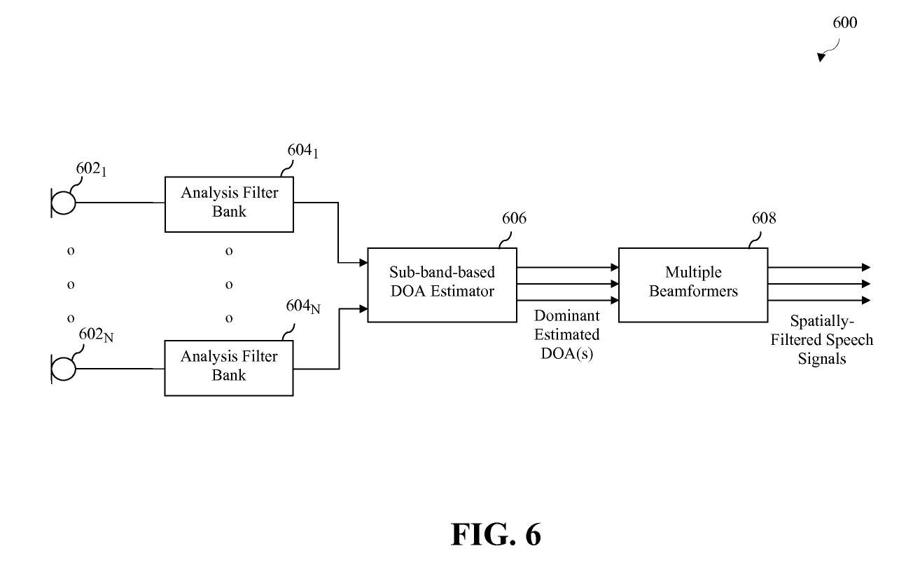

By way of illustration, FIG. 6 illustrates a block diagram of an audio teleconferencing system 600 in accordance with an embodiment of the present invention that utilizes sub-band-based DOA estimation and multiple beamformers to detect simultaneous talkers and to generate spatially-filtered speech signals associated with each. Audio teleconferencing system 600 may comprise one example implementation of audio teleconferencing system 200 of FIG. 2. As shown in FIG. 6, audio teleconferencing system 600 includes a number of interconnected components including a plurality of microphones 602₁-602_{N}, a plurality of analysis filter banks 604₁-604_{N}, a sub-band-based DOA estimator 606 and multiple beamformers 608.

Each of microphones 602₁-602_{N} operates in a well-known manner to convert sound waves into a corresponding microphone signal. Each microphone signal is then passed to a corresponding analysis filter bank 604₁-604_{N}. Each analysis filter bank 604₁-604_{N} divides a corresponding received microphone signal into a plurality of sub-band signals, each of the plurality of sub-band signals being associated with a different frequency sub-band. The sub-band signals produced by analysis filter banks 604₁-604_{N} are then passed to sub-band-based DOA estimator 606.

Sub-band-based DOA estimator 606 processes the sub-band signals received from analysis filter banks 604₁-604_{N} to determine an estimated DOA for each frequency sub-band. The estimated DOA may be represented as a lag, an angle of arrival, or some other value. Sub-band-based DOA estimator 606 may determine the estimated DOA for each sub-band using any of the techniques described above in Section C.1, including but not limited to the DOA estimation techniques described in that section that are based on a second-order cross-correlation or on fourth-order statistics.

Sub-band-based DOA estimator 606 then analyzes the estimated DOAs associated with the different sub-bands to identify a number of dominant estimated DOAs. For example, in accordance with one implementation, sub-band-based DOA estimator 606 may identify from one to three dominant estimated DOAs. The selection of the dominant estimated DOAs may be performed, for example, by performing a histogramming operation that tracks the estimated DOAs determined for each sub-band over a particular period of time. In a scenario in which there is only one active talker, it is expected that only a single dominant estimated DOA will be identified, whereas in a scenario in which there are multiple simultaneously-active talkers, it would be expected that multiple dominant estimated DOAs will be identified.

The one or more dominant estimated DOAs identified by sub-band-based DOA estimator 606 are then passed to beamformers 608. Each beamformer within beamformers 608 uses a different one of the dominant estimated DOAs to control a different beam pattern associated with the multiple microphones 602₁-602_{N}. In this way, each beamformer can “hone in” on a different active talker. In an embodiment in which up to three dominant estimated DOAs may be produced by sub-band-based DOA estimator 606, beamformers 608 may comprise three different beamformers. If there are more beamformers then there are dominant estimated DOAs (i.e., if there are more beamformers than there are currently-active talkers), then not all of the beamformers need be used. Each active beamformer within beamformers 608 then produces a corresponding spatially-filtered speech signal. These spatially-filtered speech signals can then be provided to speaker identifier 210, which will operate to identify a legitimate talker associated with each speech signal.

b. Detecting Multiple Simultaneous Talkers Using Blind Source Separation

In one embodiment, a blind source separation scheme is used to detect simultaneous active talkers and to obtain a separate speech signal associated with each. Any of the various blind source separations schemes known in the art or hereinafter developed can be used to perform this function. For example, and without limitation, J. LeBlanc et al., “Speech Separation by Kurtosis Maximization,” Proc. ICASSP 1998, Seattle, Wash., describe a system in which an adaptive demixing scheme is used that maximizes the output signal kurtosis. If such an approach is used, then the blind source separation yields M separate audio streams corresponding to M simultaneous talkers. These audio streams may then be provided to speaker identifier 210, which will operate to identify a legitimate talker associated with each audio stream.

4. Example Speaker Recognition Techniques

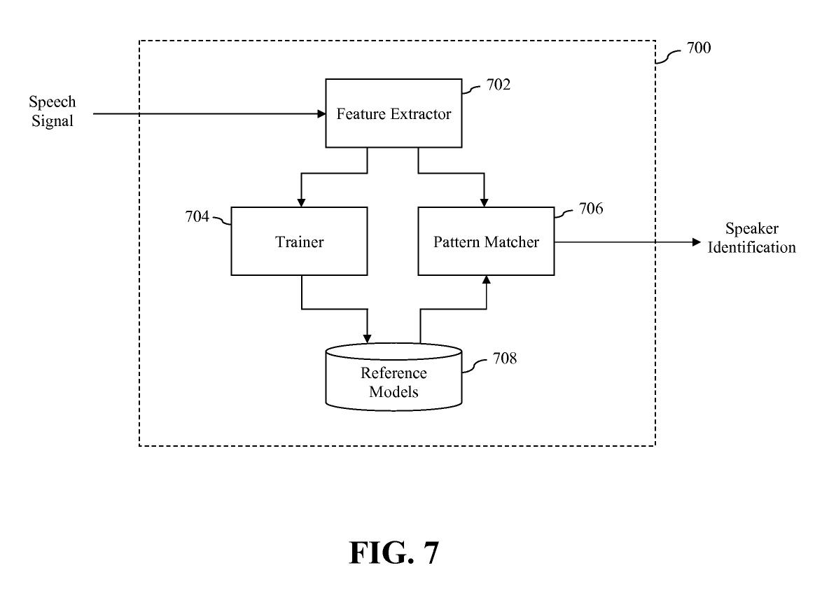

As noted above, an audio teleconferencing system in accordance with an embodiment of the present invention utilizes speaker recognition functionality to identify a particular talker in association with each speech signal generated by steerable beamformer 206 and/or blind source separator 208. FIG. 7 is a block diagram of an example speaker identification system 700 that may be used in accordance with such an embodiment. Speaker identification system 700 may be used, for example, to implement speaker identifier 210 of system 200. As shown in FIG. 7, speaker identification system 700 includes a number of interconnected components including a feature extractor 702, a trainer 704, a pattern matcher 706, and a database of reference models 708.

Feature extractor 702 is configured to acquire speech signals from steerable beamformer 206 and/or blind source separator 208 and to extract certain features therefrom. Feature extractor 702 is configured to operate both during a training process that is executed before or at the beginning of a communication session and during a pattern matching process that occurs during the communication session.

In one implementation, feature extractor 702 extracts features from a speech signal by processing multiple intervals of the speech signal, which are referred to herein as frames, and mapping each frame to a multidimensional feature space, thereby generating a feature vector for each frame. For speaker recognition, features that exhibit high speaker discrimination power, high interspeaker variability, and low intraspeaker variability are desired. Examples of various features that feature extractor 702 may extract from a speech signal are described in Campbell, Jr., J., “Speaker Recognition: A Tutorial,” Proceedings of the IEEE, Vol. 85, No. 9, September 1997, the entirety of which is incorporated by reference herein. Such features may include, for example, reflection coefficients (RCs), log-area ratios (LARs), arcsin of RCs, line spectrum pair (LSP) frequencies, and the linear prediction (LP) cepstrum. In one embodiment, a vector of voiced features is extracted for each processed frame of a speech signal. For example, the vector of voiced features may include 10 LARs and 10 LSP frequencies associated with a frame.

Trainer 704 is configured to receive features extracted by feature extractor 702 from speech signals originating from a plurality of potential speakers during the aforementioned training process and to process such features to generate a reference model for each potential speaker. Each reference model so generated is stored in reference model database 708 for subsequent use by pattern matcher 706. In order to generate highly-accurate reference models, it may be desirable to ensure that only one potential talker be active at a time during the training process. In certain embodiments, steerable beamformer 706 may also be used during the training process to target each potential talker as they speak.

In an example embodiment in which the extracted features comprise a series of N feature vectors x̅₁, x̅₂, . . . x̅_{N} corresponding to N frames of a speech signal, processing the features may comprise calculating a mean vector μ̅ and covariance matrix C where the mean vector μ̅ may be calculated in accordance with

$$\overline{μ} = \frac{1}{N} {\sum }_{i = 1}^{N} {\overline{x}}_{i}$$

and the covariance matrix C may be calculated in accordance with

$$C = \frac{1}{N - 1} {\sum }_{i = 1}^{N} ( {\overline{x}}_{i} - \overline{μ} ) \cdot {( {\overline{x}}_{i} - \overline{μ} )}^{T} .$$

However, this is only one example, and a variety of other methods may be used to process the extracted features to generate a reference model. Examples of such other methods are described in the aforementioned reference by Campbell, Jr., as well as elsewhere in the art.

Pattern matcher 706 is configured to receive features extracted by feature extractor 702 from each speech signal obtained by steerable beamformer 206 and/or blind source separator 208 during a communication session. For each set of features so received, pattern matcher 706 processes the set of features, compares the processed feature set to the reference models in reference models database 708, and generates a recognition score for each reference model based on the degree of similarity between the processed feature set and the reference model. Generally speaking, the greater the similarity between a processed feature set and a reference model, the more likely that the talker represented by the reference model is the source of the speech signal from which the processed feature set was obtained. Based on the recognition scores so generated, pattern matcher 706 determines whether a particular talker represented by one of the reference models should be identified as the source of the speech signal. If a talker is so identified, then pattern matcher 706 outputs information identifying the talker to spatial mapping information generator 214.

The foregoing pattern matching process preferably includes extracting the same feature types as were extracted during the training process to generate reference models. For example, in an embodiment in which the training process comprises building reference models by extracting a feature vector of 10 LARs and 10 LSP frequencies for each frame of a speech signal processed, the pattern matching process may also include extracting a feature vector of 10 LARs and 10 LSP frequencies for each frame of a speech signal processed.

In further accordance with a previously-described example embodiment, generating a processed feature set during the pattern matching process may comprise calculating a mean vector μ̅ and covariance matrix C. To improve performance, these elements may be calculated recursively for each frame of a speech signal received. For example, denoting an estimate based upon N frames as μ̅_{N} and on N+1 frames as μ̅_{N+1}, the mean vector may be calculated recursively in accordance with

$${\overline{μ}}_{N + 1} = {\overline{μ}}_{N} + \frac{1}{N + 1} ( {\overline{x}}_{N + 1} - {\overline{μ}}_{N} ) .$$

Similarly, the covariance matrix C may be calculated recursively in accordance with

$${C}_{N + 1} = \frac{N - 1}{N} {C}_{N} + \frac{1}{N + 1} ( {\overline{x}}_{N + 1} - {μ}_{N} ) \cdot {( {\overline{x}}_{N + 1} - {\overline{μ}}_{N} )}^{T} .$$

However, this is only one example, and a variety of other methods may be used to process each set of extracted features. Examples of such other methods are described in the aforementioned reference by Campbell, Jr., as well as elsewhere in the art.

### D. Example Telephony System in Accordance with an Embodiment of the Present Invention

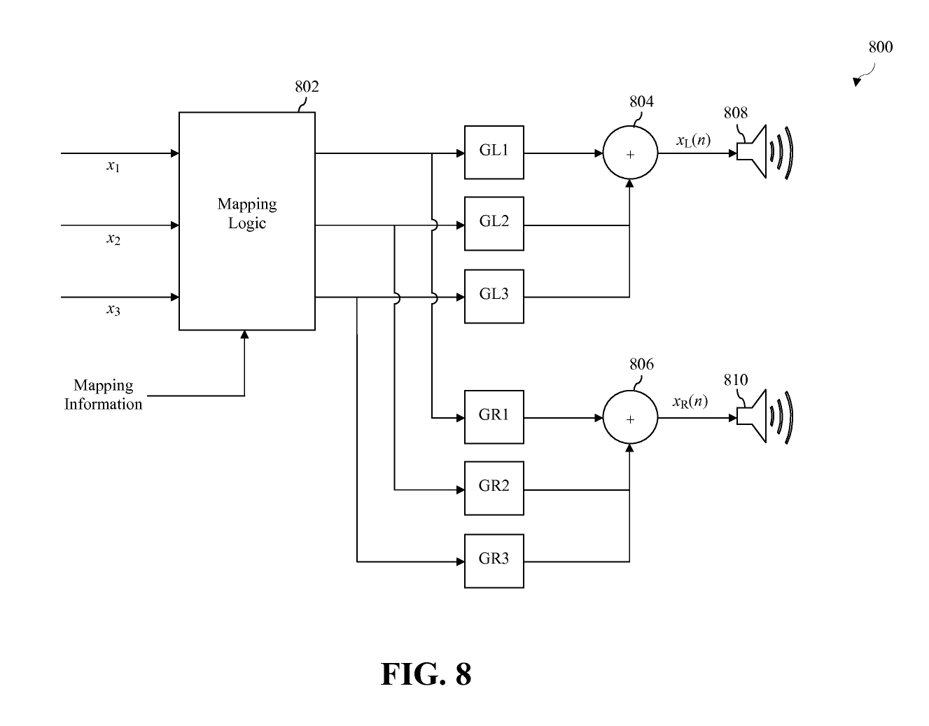

FIG. 8 is a block diagram of an example telephony system 800 that enables one or more persons on one end of a communication session to listen to and distinguish between multiple talkers on another end of the communication session, wherein the multiple talkers are all using the same audio teleconferencing system. Telephony system 800 is intended to represent just one example implementation of telephony system 104, which was described above in reference to communications system 100 of FIG. 1.

As shown in FIG. 8, telephony system 800 includes mapping logic 802 that receives speech signals, denoted x₁, x₂ and x₃, and mapping information from a remote audio teleconferencing system, such as audio teleconferencing system 102, via a communications network, such as communications network 106. Audio teleconferencing system 102 and communications network 106 were each described above in reference to communications system 100 of FIG. 1. The speech signals received from the remote audio teleconferencing system are each obtained from a different active talker. The mapping information received from the remote audio teleconferencing system includes information that at least identifies a particular talker associated with each received speech signal.

Mapping logic 802 utilizes well-known audio spatialization techniques to assign each speech signal associated with each identified talker to a corresponding audio spatial region based on the mapping information and then makes use of multiple loudspeakers to play back each speech signal in its assigned audio spatial region. In the context of system 800, which is shown to be a two-loudspeaker system, this process involves the generation and application of complex gains to each speech signal, one complex gain being applied to generate a left-channel component of the speech signal and another complex gain being applied to generate a right-channel component of the speech signal. For example, in FIG. 8, a complex gain GL1 is applied to speech signal x₁ to generate a left-channel component of speech signal x₁ and a complex gain GR1 is applied to speech signal x₁ to generate a right-channel component of speech signal x₁. The application of these complex gains alters a delay and magnitude associated with each speech signal in a desired fashion, thus helping to create the audio spatial regions. A combiner 804 combines the left-channel components of each speech signal to generate a left-channel audio signal x_{L}(n) that is played back by a left loudspeaker 808. A combiner 806 combines the right-channel components of each speech signal to generate a right-channel audio signal x_{R}(n) that is played back by a right loudspeaker 810.

Although telephony system 800 is shown as receiving three speech signals and mapping the three speech signals to three audio spatial regions, persons skilled in the relevant art(s) will appreciate that, depending upon the implementation, any number of speech signals can be mapped to any number of different audio spatial regions using well-known audio spatialization techniques. Furthermore, although telephony system 800 is shown as comprising two loudspeakers, it is to be understood that audio spatialization can be achieved using a greater number of loudspeakers. By way of example, the audio spatialization can be achieved using a 5.1 or 7.1 surround sound system.

In an alternate embodiment of the present invention, the mapping and audio spatialization operations performed by telephony system 800 to generate audio signals for different channels (e.g., audio signals x_{L}(n) and x_{R}(n)) may all be performed by the remote audio teleconferencing system (e.g., audio teleconferencing system 102). In this case, the audio signals for each channel are simply transmitted from the remote audio teleconferencing system to the telephony system and played back by the appropriate loudspeakers associated with each audio channel.

### E. Example Methods and Usage Scenarios in Accordance with Embodiments of the Present Invention

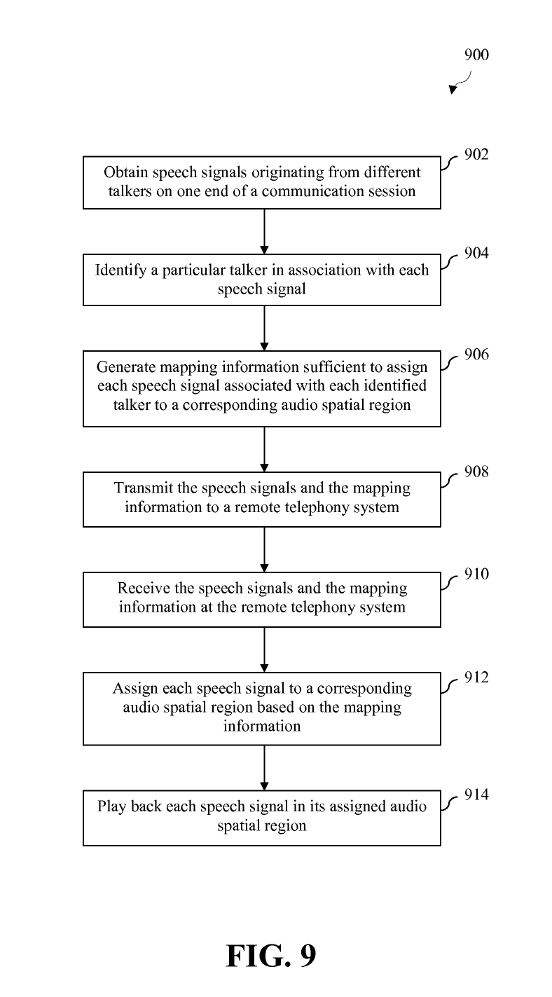

FIG. 9 depicts a flowchart 900 of an example method for using audio spatialization to help at least one listener on one end of a communication session differentiate between multiple talkers on another end of the communication session in accordance with an embodiment of the present invention. The method of flowchart 900 will now be described. In the description, illustrative reference is made to various system elements described above in reference to FIGS. 1-8. However, the method is not limited to those implementations and the steps of flowchart 900 may be performed by other systems or elements.

As shown in FIG. 9, the method of flowchart 900 begins at step 902 in which speech signals originating from different talkers on one end of a communication system are obtained. This step may be performed, for example, by audio teleconferencing system 102 of FIG. 1 using at least one microphone.

In one embodiment, the performance of step 902 includes generating a plurality of microphone signals by a microphone array, periodically processing the plurality of microphone signals to produce an estimated DOA associated with an active talker, and producing each speech signal by adapting a spatial directivity pattern associated with the microphone array based on one of the periodically-produced estimated DOAs. For example, with reference to audio teleconferencing system 200, the microphone array may comprise microphone array 202, the periodic production of the estimated DOA may be performed by DOA estimator 204, and the production of each speech signal through adaptation of the spatial directivity pattern associated with the microphone array may be performed by steerable beamformer 206. The steerable beamformer may comprise, for example, a Minimum Variance Distortionless Response (MVDR) beamformer or any other suitable beamformer for performing this function.

In one embodiment, the processing of the plurality of microphone signals to produce an estimated DOA associated with an active talker includes calculating a fourth-order cross-cumulant between two of the microphone signals. For example, as described elsewhere herein, the processing of the plurality of microphone signals to produce an estimated DOA associated with an active talker may include finding a lag that maximizes a real part of a normalized fourth-order cross-cumulant that is calculated between two of the microphone signals. In certain implementations, this operation may be performed on a frequency sub-band basis.

In a further embodiment, the processing of the plurality of microphone signals to produce an estimated DOA associated with an active talker includes processing a candidate estimated DOA determined for each of a plurality of frequency sub-bands based on the microphone signals. In accordance with such an embodiment, processing the candidate estimated DOA determined for each of the plurality of frequency sub-bands based on the microphone signals may include applying a weight to each candidate DOA based on a determination of whether the frequency sub-band associated with the candidate DOA comprises speech energy. As described elsewhere herein, the determination of whether the frequency sub-band associated with the candidate DOA comprises speech energy may be made based on a kurtosis calculated for a microphone signal in the frequency sub-band or a cross-kurtosis calculated between two microphone signals in the frequency sub-band.

In another embodiment, the performance of step 902 includes generating a plurality of microphone signals by a microphone array, processing the plurality of microphone signals in a sub-band-based DOA estimator to produce multiple estimated DOAs associated with multiple active talkers, and producing by each beamformer in a plurality of beamformers a different speech signal by adapting a spatial directivity pattern associated with the microphone array based on a corresponding one of the estimated DOAs received from the sub-band-based DOA estimator. For example, with reference to audio teleconferencing system 600, the microphone array may comprise microphones 602₁-602_{N}, the production of the multiple estimated DOAs may be performed by sub-band-based DOA estimator 606, and the production of the multiple speech signals by a plurality of beamformers based on the multiple estimated DOAs may be performed by multiple beamformers 608.

In a further embodiment, the performance of step 902 includes generating a plurality of microphone signals by a microphone array and processing the plurality of microphone signals by a blind source separator to produce multiple speech signals originating from multiple active talkers. For example, with reference to audio teleconferencing system 200, the microphone array may comprise microphone array 202 and the blind source separator may comprise blind source separator 208.

After step 902, control flows to step 904 during which a particular talker is identified in association with each speech signal obtained during step 902. This step may be performed, for example, by speaker identifier 210 of audio teleconferencing system 200. In one embodiment, step 904 is performed using automated speaker recognition functionality. Such automated speaker recognition functionality may identify a particular talker in association with each speech signal by comparing processed features associated with each speech signal to a plurality of reference models associated with a plurality of potential talkers in a like manner to that described above in reference to speaker identification system 700 of FIG. 7, although alternative approaches may be used.

During step 906, mapping information is generated that is sufficient to assign each speech signal associated with each identified talker during step 904 to a corresponding audio spatial region. This step may be performed, for example, by spatial mapping information generator 212 of audio teleconferencing system 200. Such mapping information may include, for example, any type of information or data structure that associates a particular speech signal with a particular talker.

At step 908, the speech signals and mapping information are transmitted to a remote telephony system. This step may be performed, for example, by audio teleconferencing system 102 of communications system 100, wherein the speech signals and mapping information are transmitted to telephony system 104 via communications network 106. As will be appreciated by persons skilled in the relevant art(s), the manner by which such information is transmitted will depend upon the various data transfer protocols used by the network or networks that serve to connect the entity transmitting the speech signals and mapping information and the remote telephony system.

During step 910, the speech signals and mapping information are received at the remote telephony system. This step may be performed, for example, by telephony system 104 of communication system 100.

During step 912, each speech signal received during step 910 is assigned to a corresponding audio spatial region based on the mapping information received during step 910. This step may be performed, for example, by telephony system 104 of communication system 100. This step may involve assigning each speech signal to a fixed audio spatial region that is assigned to an identified talker associated with the speech signal.

At step 914, each speech signal is played back in its assigned audio spatial region. This step may be performed, for example, by telephony system 104 of communication system 100. As described above in reference to example telephony system 800 of FIG. 8, this step may comprise applying complex gains to each speech signal to generate a plurality of audio channel signals, and then playing back the audio channel by corresponding loudspeakers.

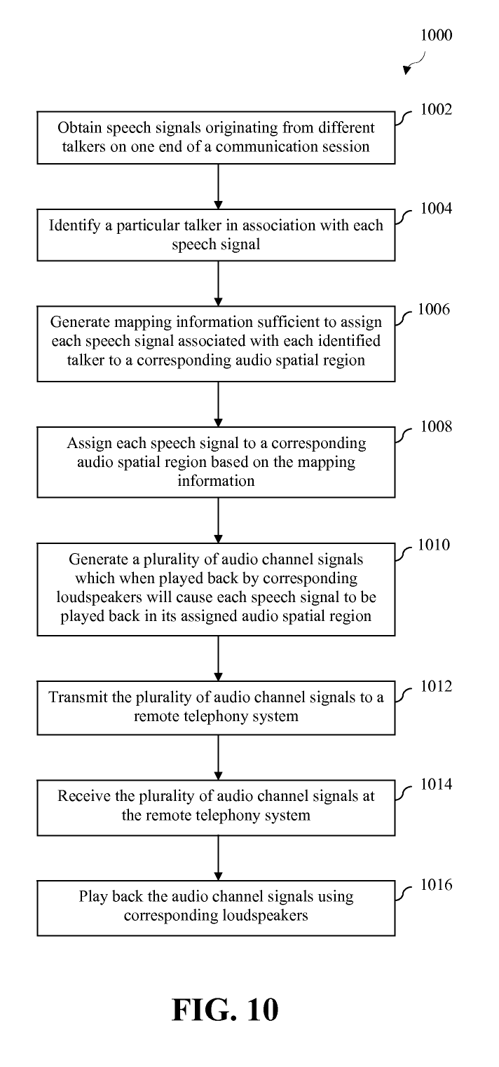

FIG. 10 depicts a flowchart 1000 of an alternative example method for using audio spatialization to help at least one listener on one end of a communication session differentiate between multiple talkers on another end of the communication session in accordance with an embodiment of the present invention. The method of flowchart 1000 will now be described. In the description, illustrative reference is made to various system elements described above in reference to FIGS. 1-8. However, the method is not limited to those implementations and the steps of flowchart 1000 may be performed by other systems or elements.

As shown in FIG. 10, the method of flowchart 1000 begins at step 1002 in which speech signals originating from different talkers on one end of a communication system are obtained. During step 1004, a particular talker is identified in association with each speech signal obtained during step 1002 and during step 1006, mapping information is generated that is sufficient to assign each speech signal associated with each identified talker during step 1004 to a corresponding audio spatial region. Steps 1002, 1004 and 1006 of flowchart 1000 are essentially the same as steps 902, 904 and 906 of flowchart 900 as described above in reference to FIG. 9, and thus no additional description will be provided for those steps.

During step 1008, each speech signal is assigned to a corresponding audio spatial region based on the mapping information. In contrast to flowchart 900, in which this function was performed by a remote telephony system, this step of flowchart 1000 is performed by the same entity that obtained the speech signals and generated the mapping information. For example, this step may be performed by audio teleconferencing system 102 of system 100.

At step 1010, a plurality of audio channel signals are generated which, when played back by corresponding loudspeakers, will cause each speech signal to be played back in its assigned audio spatial region. Like step 1008, this step is performed by the same entity that obtained the speech signals and generated the mapping information. For example, this step may also be performed by audio teleconferencing system 102 of system 100. As described above in reference to example telephony system 800 of FIG. 8, this step may comprise applying complex gains to each speech signal to generate a plurality of audio channel signals.

At step 1012, the plurality of audio channel signals is transmitted to a remote telephony system. This step may be performed, for example, by audio teleconferencing system 102 of communications system 100, wherein the plurality of audio channel signals are transmitted to telephony system 104 via communications network 106. As will be appreciated by persons skilled in the relevant art(s), the manner by which such information is transmitted will depend upon the various data transfer protocols used by the network or networks that serve to connect the entity transmitting the speech signals and mapping information and the remote telephony system.

During step 1014, the plurality of audio channel signals is received at the remote telephony system. This step may be performed, for example, by telephony system 104 of communication system 100.

At step 1016, the remote telephony system plays back the audio channel signals using corresponding loudspeakers, thereby causing each speech signal to be played back in its assigned audio spatial region. This step may also be performed, for example, by telephony system 104 of communication system 100.

The method of flowchart 1000 differs from that of flowchart 900 in that the mapping of speech signals associated with identified talkers to different audio spatial regions and the generation of audio channel signals that contain the spatialized speech signals occurs at the entity that obtained the speech signals rather than the remote telephony system. Thus, in accordance with the method of flowchart 1000, only the audio channel signals need be transmitted over the network and the remote telephony system need not implement the audio spatialization functionality.

Each of the foregoing methods can advantageously be used to help at least one listener on one end of a communication session differentiate between multiple talkers on another end of the communication session. Certain embodiments can help to differentiate between multiple talkers even when the talkers are moving or talking simultaneously. Various operational scenarios will now be described that will help to illustrate advantages of embodiments of the present invention. These operational scenarios describe embodiments of the present invention that provide particular features. However, the present invention is not limited to such embodiments.

A first usage scenario will now be described. After a training period during which an audio teleconferencing system in accordance with an embodiment of the present invention builds a reference model for each of a plurality of potential talkers on one end of a communication session, one of the potential talkers is actively talking. A DOA estimator within the audio teleconferencing system determines an estimated DOA of sound waves emanating from the active talker and provides the estimated DOA to a beamformer within the audio teleconferencing system. The beamformer processes microphone signals received via a microphone array of the audio teleconferencing system to produce a spatially-filtered speech signal associated with the active talker. A speaker identifier within the audio teleconferencing system identifies the active talker as “talker D,” assigned to “audio spatial region 5.” The spatially-filtered speech signal and the associated mapping information is then transmitted to a remote telephony system, which uses the mapping information to reproduce the speech signal associated with “talker D” in “audio spatial region 5.”

The active talker then changes location. The DOA estimator identifies a new estimated DOA and provides it to the beamformer, which adjusts its beam pattern accordingly. The speaker identifier that the spatially-filtered speech signal produced by the beamformer is still associated with “talker D,” and thus the audio spatial region is still “audio spatial region 5.” The spatially-filtered speech signal and the associated mapping information is then transmitted to the remote telephony system, which continues to play back the speech signal in “audio spatial region 5.” Thus, any remote listeners will still hear the voice of “talker D” emanating from the same audio spatial region, even though the talker has moved locations.

A second usage scenario will now be described. After a training period during which an audio teleconferencing system in accordance with an embodiment of the present invention builds a reference model for each of a plurality of potential talkers on one end of a communication session, one of the potential talkers is actively talking. A DOA estimator within the audio teleconferencing system determines an estimated DOA of sound waves emanating from the active talker and provides the estimated DOA to a beamformer within the audio teleconferencing system. The beamformer processes microphone signals received via a microphone array of the audio teleconferencing system to produce a spatially-filtered speech signal associated with the active talker. A speaker identifier within the audio teleconferencing system identifies the active talker as “talker D,” assigned to “audio spatial region 5.” The spatially-filtered speech signal and the associated mapping information is then transmitted to a remote telephony system, which uses the mapping information to reproduce the speech signal associated with “talker D” in “audio spatial region 5.”

“Talker D” then stops talking and another legitimate talker starts talking from a nearby location. The DOA estimator identifies a slight change in the estimated DOA and the beamformer adjusts its beam pattern accordingly. The speaker identifier determines that the spatially-filtered speech signal produced by the beamformer is now “talker E,” assigned to “audio spatial region 3.” The spatially-filtered speech signal and the associated mapping information is then transmitted to a remote telephony system, which uses the mapping information to reproduce the speech signal associated with “talker E” in “audio spatial region 3.” Thus, any remote listeners will hear the voice of the new talker emanating from a different audio spatial region.

A third example usage scenario will now be described. After a training period during which an audio teleconferencing system in accordance with an embodiment of the present invention builds a reference model for each of a plurality of potential talkers on one end of a communication session, one of the potential talkers is actively talking. A DOA estimator within the audio teleconferencing system determines an estimated DOA of sound waves emanating from the active talker and provides the estimated DOA to a beamformer within the audio teleconferencing system. The beamformer processes microphone signals received via a microphone array of the audio teleconferencing system to produce a spatially-filtered speech signal associated with the active talker. A speaker identifier within the audio teleconferencing system identifies the active talker as “talker D,” assigned to “audio spatial region 5.” The spatially-filtered speech signal and the associated mapping information is then transmitted to a remote telephony system, which uses the mapping information to reproduce the speech signal associated with “talker D” in “audio spatial region 5.”

“Talker D” keeps talking and another legitimate talker starts talking from a nearby location. The DOA estimator identifies two estimated DOAs and two different beamformers adjust their beam patterns accordingly to produce two corresponding spatially-filtered speech signals. Alternatively, a blind source separator within the audio teleconferencing system generates two output speech signals. The speaker identifier identifies both active talkers and their respective audio spatial regions. The speech signals associated with both active talkers and the corresponding mapping information is transmitted to the remote telephony system. The remote telephony system receives the speech signals and mapping information and plays back the speech signals in their associated audio spatial regions. Thus, any remote listeners will hear the voices of the two active talkers emanating from two different audio spatial regions.

### F. Example Alternative Implementations

Although embodiments of the present invention described above assign speech signals associated with different identified talkers to different fixed audio spatial regions, other embodiments may assign speech signals associated with different identified talkers to audio spatial regions or locations that are not fixed. For example, in one embodiment, an audio teleconferencing system may generate and transmit information relating to a current location of each active talker, and a remote telephony system may utilize audio spatialization to play back the speech signal associated with each active talker from an audio spatial location that is related to the current location of the active talker. In this way, when an active talker changes location, such as by moving across a room, the remote telephony system can simulate this by changing the spatial origin of the talker's voice in a like manner. Numerous other audio spatialization schemes may be used that map speech signals associated with different identified users to different audio spatial regions or locations.

In one embodiment described above, the generation of audio channel signals that map different active talkers to different audio spatial regions is performed by a remote telephony device while in an alternate embodiment, this function is performed by an audio teleconferencing system and the audio channels signals are transmitted to the remote telephony device. In a still further embodiment, an intermediate entity that is communicatively connected to both the audio teleconferencing system and the remote telephony system generates audio channel signals that map different active talkers to different audio spatial regions based on speech signals and mapping information received from the audio teleconferencing system and then transmits the audio channel signals to the remote telephony system for playback.

In addition to performing audio spatialization as described above, a remote telephony system may utilize speech signals and mapping information received from an audio teleconferencing system to provide various other visual or auditory cues to a remote listener concerning which of a plurality of potential talkers is currently talking. For example, in a video teleconferencing scenario, the identified talker associated with a speech signal that is currently being played back can be identified by somehow highlighting the current video image of the talker. As another example, a name or other identifier of the active talker(s) may be rendered to an alphanumeric or graphic display. Still other cues may be used.

Although certain embodiments described above relate to a telephony application, embodiments of the present invention may be used in virtually any system that is capable of capturing the voices of multiple talkers for transmission to one or more remote listeners. For example, the concepts described above could conceivably be used in an online gaming or social networking application in which multiple game players or participants located in the same room are allowed to communicate with remote players or participants via a network, such as the Internet. The use of the concepts described above would allow a remote game player or participant to better distinguish between the voices of the different game players or participants that are located in the same room.

The concepts described herein are likewise applicable to systems that record the voices of multiple speakers located in the same room or other area for any purpose whatsoever. For example, the concepts described herein could allow for an archived audio recording of a meeting to be played back such that the voices of different meeting participants emanate from different audio spatial regions or location. In this case, rather than transmitting speech signals and mapping information in real-time, such information would be recorded and then subsequently used to perform audio spatialization operations. The functionality described herein that is capable of identifying and associating different active talkers with their speech could also be used in conjunction with automatic speech recognition technology to automatically generate a written transcript of a meeting that attributes what was said during the meeting to the person who said it. The concepts described above may be used in still other applications not described herein.

### G. Example Computer System Implementation

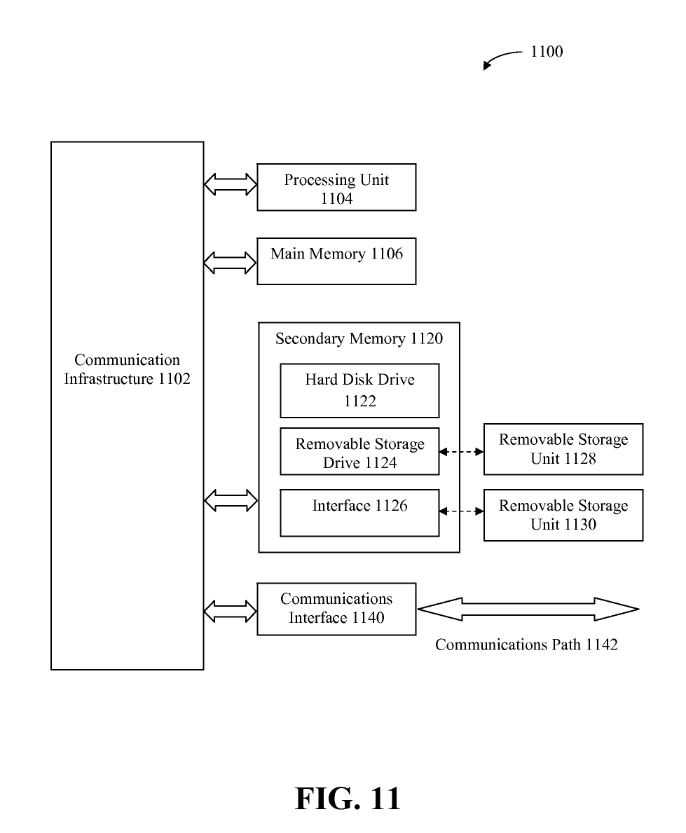

Various functional elements of the systems depicted in FIGS. 1-8 and various steps of the flowcharts depicted in FIGS. 9 and 10 may be implemented by one or more processor-based computer systems. An example of such a computer system 1100 is depicted in FIG. 11.

As shown in FIG. 11, computer system 1100 includes a processing unit 1104 that includes one or more processors or processor cores. Processing unit 1104 is connected to a communication infrastructure 1102, which may comprise, for example, a bus or a network.

Computer system 1100 also includes a main memory 1106, preferably random access memory (RAM), and may also include a secondary memory 1120. Secondary memory 1120 may include, for example, a hard disk drive 1122, a removable storage drive 1124, and/or a memory stick. Removable storage drive 1124 may comprise a floppy disk drive, a magnetic tape drive, an optical disk drive, a flash memory, or the like. Removable storage drive 1124 reads from and/or writes to a removable storage unit 1128 in a well-known manner. Removable storage unit 1128 may comprise a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into computer system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from the removable storage unit 1130 to computer system 1100.

Computer system 1100 may also include a communication interface 1140. Communication interface 1140 allows software and data to be transferred between computer system 1100 and external devices. Examples of communication interface 1140 may include a modem, a network interface (such as an Ethernet card), a communications port, a PCMCIA slot and card, or the like. Software and data transferred via communication interface 1140 are in the form of signals which may be electronic, electromagnetic, optical, or other signals capable of being received by communication interface 1140. These signals are provided to communication interface 1140 via a communication path 1142. Communications path 1142 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1128, removable storage unit 1130 and a hard disk installed in hard disk drive 1122. Computer program medium and computer readable medium can also refer to memories, such as main memory 1106 and secondary memory 1120, which can be semiconductor devices (e.g., DRAMs, etc.). These computer program products are means for providing software to computer system 1100.

Computer programs (also called computer control logic, programming logic, or logic) are stored in main memory 1106 and/or secondary memory 1120. Computer programs may also be received via communication interface 1140. Such computer programs, when executed, enable the computer system 1100 to implement features of the present invention as discussed herein. Accordingly, such computer programs represent controllers of the computer system 1100. Where the invention is implemented using software, the software may be stored in a computer program product and loaded into computer system 1100 using removable storage drive 1124, interface 1126, or communication interface 1140.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### H. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

### I. Appendix

### HOS Derivations

First, it is shown that the 4^{th} order cumulants of a harmonic signal is non-zero and can be expressed as function of the 2^{nd} order statistics (energy) of the signal.

From the general expression of the 4^{th} order cumulant:

C_{z}_{₁}_{z}_{₂}_{z}_{₃}_{z}_{₄}⁴=E[z₁z₂z₃z₄]−E[z₁z₂]E[z₃z₄]−E[z₁z₃]E[z₂z₄]−E[z₁z₄]E[z₂z₃]

where z₁, z₂, z₃, z₄ represent time samples of the same signal (separated by a given lag), or different signals, set:

x₁≡z₁=z₃ x*₁≡z₂=z₄

To obtain the expression of the 4^{th} order cumulant (at lag zero):

Cₓ_{₁}⁴=E[x₁(n)x*₁(n)x₁(n)x*₁(n)]−E[x₁(n)x*₁(n)]E[x₁(n)x*₁(n)]−E[x₁²(n)]E[x*₁²(n)]−E[x₁(n)x*₁(n)]E[x*₁(n)x₁(n)]

Cₓ_{₁}⁴=E[|x₁(n)|²|x₁(n)|²]−2(E[|x₁(n)|²])²−E[x₁²(n)]E[x*₁²(n)]

Let the case of a harmonic signal of the form:

x₁=a₁e^{-jω}_{₁}ⁿ

It is easy to show that

E[|x₁(n)|²]=a₁², E[|x₁(n)|²|x₁(n)|²]=a₁⁴, and E[x₁²(n)]=[x*₁²(n)]=0,

Thus, the 4^{th} order cumulant is:

Cₓ_{₁}⁴=−a₁⁴

and the relation between the 2^{nd} and the 4^{th} order cumulant is:

Cₓ_{₁}⁴=−{E[|x₁(n)|²]}²=−{Cₓ_{₁}²}²

Therefore, the 4^{th} order cumulant at lag 0 (or kurtosis) of a harmonic signal can be written as a function of the squared energy (or 2^{nd} order cumulant) of the signal. The above derivation can be extended to the case of 2 or more harmonics and yield similar results.

Second, it is shown that the cross-cumulant between 2 harmonic signals separated by a time delay reaches a maximum negative value when the correlation lag matches the time delay.

The signal from the two microphones can be written as a delayed version of the source:

X₁(n)=Sₙ=Ae^{jwn}

X₂(n)=S_{n-L}_{₀}=Be^{jw(n-L}^{₀}⁾

The cross-cumulant between the two signals at a lag L is:

C_{X}_{₁}_{X}_{₂}⁴(L)=E[X₁²(n)X*₂²(n+L)]−E[X₁²(n)]E*[X₂²(n+L)]−2(E[X₁(n)X*₂(n+L)])²

and given

X₁²(n)=A²e^{j2wn} X₂²(n)=B²e^{j2w(n-L}^{₀}⁾, X*₂²(n)=B²e^{-j2w(n-L}^{₀}⁾, X*₂(n)=Be^{-jw(n-L}^{₀}⁾, and X₂(n+L)=Be_{jw(n-L}^{₀}^{+L)}

The first term in the cross-cumulant is:

E[X₁²(n)X*₂²(n+L)]=A²B²e^{-j2w(L-L}^{₀}⁾

The second term is:

E[X₁²(n)]E*[X₂²(n+L)]=0

The third term is:

E[X₁(n)X*₂(n+L)]=A·B·e^{-jw(L-L}^{₀}⁾

Combining the terms yields the expression for the cross cumulant:

C_{X}_{₁}_{X}_{₂}⁴(L)=−A²B²e^{-j2w(L-L}^{₀}⁾

and the normalized cross cumulant is:

$$\begin{matrix}{Norm\_C}_{{X}_{1} {X}_{2}}^{4} ( L ) = \frac{{C}_{{X}_{1} {X}_{2}}^{4} ( L )}{\sqrt{{C}_{{X}_{1}}^{4} ( 0 ) {C}_{{X}_{2}}^{4} ( 0 )}} \\ = \frac{- {A}^{2} {B}^{2} {e}^{j2 w ( {L}_{0} - L )}}{\sqrt{( - {A}^{4} ) ( - {B}^{4} )}} \\ = - {e}^{j2 w ( {L}_{0} - L )}\end{matrix}$$

Thus both the cross cumulant and its normalized version reach maximum (negative) value when the lag matches the time delay: L=L₀.

What is claimed is:

1. A communications system, comprising:
an audio teleconferencing system that is configured to obtain speech signals originating from different talkers on one end of a communication session, to identify a particular talker in association with each speech signal, and to generate mapping information sufficient to assign each speech signal associated with each identified talker to a corresponding audio spatial region; and
a telephony system communicatively connected to the audio teleconferencing system via a communications network, the telephony system configured to receive the speech signals and the mapping information from the audio teleconferencing system, to assign each speech signal received from the audio teleconferencing system to a corresponding audio spatial region based on the mapping information, and to play back each speech signal in its assigned audio spatial region.

2. The communication system of claim 1, wherein the telephony system is configured to assign each speech signal received from the audio teleconferencing to a fixed spatial region that is assigned to an identified talker associated with the speech signal.

3. An audio teleconferencing system, comprising:
at least one microphone that is used to obtain speech signals originating from different talkers;
a speaker identifier that identifies a talker associated with each speech signal; and
a spatial mapping information generator that generates mapping information sufficient to assign each speech signal associated with each identified talker to a corresponding audio spatial region.

4. The system of claim 3, wherein the at least one microphone comprises a microphone array that generates a plurality of microphone signals, the system further comprising:
a direction of arrival (DOA) estimator that periodically processes the plurality of microphone signals to produce an estimated DOA associated with an active talker; and
a beamformer that produces each speech signal by adapting a spatial directivity pattern associated with the microphone array based on an estimated DOA received from the DOA estimator.

5. The system of claim 4, wherein the DOA estimator produces the estimated DOA by calculating a fourth-order cross-cumulant between two of the microphone signals.

6. The system of claim 5, wherein the DOA estimator produces the estimated DOA by determining a lag that maximizes a real part of a normalized fourth-order cross-cumulant that is calculated between two of the microphone signals.

7. The system of claim 4, wherein the DOA estimator produces the estimated DOA by selecting an adaptive filter that aligns the microphone signals based on 2^{nd} order criteria of optimality and deriving the estimated DOA from the coefficients of the selected adaptive filter.

8. The system of claim 4, wherein the DOA estimator produces the estimated DOA by selecting an adaptive filter that aligns the microphone signals based on a 4^{th} order cumulant criteria of optimality and deriving the estimated DOA from the coefficients of the selected adaptive filter.

9. The system of claim 4, wherein the DOA estimator produces the estimated DOA by processing a candidate estimated DOA determined for each of a plurality of frequency sub-bands based on the microphone signals.

10. The system of claim 9, wherein the DOA estimator applies a weight to each candidate DOA based on a determination of whether the frequency sub-band associated with the candidate DOA comprises speech energy, the determination being based on a kurtosis calculated for a microphone signal in the frequency sub-band and a cross-kurtosis calculated between two microphone signals in the frequency sub-band.

11. The system of claim 4, wherein the beamformer comprises a Minimum Variance Distortionless Response (MVDR) beamformer.

12. The system of claim 3, wherein the at least one microphone comprises a microphone array that generates a plurality of microphone signals, the system further comprising:
a sub-band-based direction of arrival (DOA) estimator that processes the plurality of microphone signals to produce multiple estimated DOAs associated with multiple active talkers; and
a plurality of beamformers, each beamformer configured to produce a different speech signal by adapting a spatial directivity pattern associated with the microphone array based on a corresponding one of the estimated DOAs received from the DOA estimator.

13. The system of claim 3, wherein the at least one microphone comprises a microphone array that generates a plurality of microphone signals, the system further comprising:
a blind source separator that processes the plurality of microphone signals to produce multiple speech signals originating from multiple active talkers.

14. The system of claim 3, wherein the speaker identifier identifies a talker associated with each speech signal by comparing processed features associated with each speech signal to a plurality of reference models associated with a plurality of potential talkers.

15. A method, comprising:
obtaining speech signals originating from different talkers on one end of a communication session using at least one microphone;
identifying a particular talker in association with each speech signal; and
generating mapping information sufficient to assign each speech signal associated with each identified talker to a corresponding audio spatial region.

16. The method of claim 15, further comprising:
transmitting the speech signals and the mapping information to a remote telephony system.

17. The method of claim 15, further comprising:
receiving the speech signals and the mapping information at the remote telephony system;
assigning each speech signal to a corresponding audio spatial region based on the mapping information; and
playing back each speech signal in its assigned audio spatial region.

18. The method of claim 17, wherein assigning each speech signal to a corresponding audio spatial region based on the mapping information comprises assigning each speech signal to a fixed audio spatial region that is assigned to an identified talker associated with the speech signal.

19. The method of claim 15, further comprising:
assigning each speech signal to a corresponding audio spatial region based on the mapping information;
generating a plurality of audio channel signals which when played back by corresponding loudspeakers will cause each speech signal to be played back in its assigned audio spatial region; and
transmitting the plurality of audio channel signals to a remote telephony system.

20. The method of claim 15, wherein obtaining the speech signals originating from the different talkers on one end of the communication session using the at least one microphone comprises:
generating a plurality of microphone signals by a microphone array;
periodically processing the plurality of microphone signals to produce an estimated DOA associated with an active talker; and
producing each speech signal by adapting a spatial directivity pattern associated with the microphone array based on one of the periodically-produced estimated DOAs.

21. The method of claim 20, wherein processing the plurality of microphone signals to produce an estimated DOA associated with an active talker comprises calculating a fourth-order cross-cumulant between two of the microphone signals.

22. The method of claim 21, wherein processing the plurality of microphone signals to produce an estimated DOA associated with an active talker comprises maximizing a real part of a normalized fourth-order cross-cumulant that is calculated between two of the microphone signals.

23. The method of claim 20, wherein processing the plurality of microphone signals to produce an estimated DOA associated with an active talker comprises processing a candidate estimated DOA determined for each of a plurality of frequency sub-bands based on the microphone signals.

24. The method of claim 23, wherein processing the candidate estimated DOA determined for each of the plurality of frequency sub-bands based on the microphone signals comprises applying a weight to each candidate DOA based on a determination of whether the frequency sub-band associated with the candidate DOA comprises speech energy, the determination being based on a kurtosis calculated for a microphone signal in the frequency sub-band and a cross-kurtosis calculated between two microphone signals in the frequency sub-band.

25. The method of claim 20, wherein producing each speech signal by adapting a spatial directivity pattern associated with the microphone array based on one of the periodically-produced estimated DOAs comprises adapting the spatial directivity pattern in accordance with a Minimum Variance Distortionless Response (MVDR) beamforming algorithm.

26. The method of claim 15, wherein obtaining the speech signals originating from the different talkers on one end of the communication session using the at least one microphone comprises:
generating a plurality of microphone signals by a microphone array;
processing the plurality of microphone signals in a sub-band-based direction of arrival (DOA) estimator to produce multiple estimated DOAs associated with multiple active talkers; and
producing by each beamformer in a plurality of beamformers a different speech signal by adapting a spatial directivity pattern associated with the microphone array based on a corresponding one of the estimated DOAs received from the sub-band-based DOA estimator.

27. The method of claim 15, wherein obtaining the speech signals originating from the different talkers on one end of the communication session using the at least one microphone comprises:
generating a plurality of microphone signals by a microphone array;
processing the plurality of microphone signals by a blind source separator to produce multiple speech signals originating from multiple active talkers.

28. The method of claim 15, wherein identifying a particular talker in association with each speech signal comprises comparing processed features associated with each speech signal to a plurality of reference models associated with a plurality of potential talkers.
